(19) United States
(12) Patent Application Publication
(10) Pub. No.: US 2014/0182540 A1
(43) Pub. Date: Jul. 3, 2014

(54) COMBUSTION ENGINE, CYLINDER FOR A COMBUSTION ENGINE, AND CYLINDER LINER FOR A COMBUSTION ENGINE

(71) Applicant: Staffan Johansson, Goteborg (SE)

(72) Inventor: Staffan Johansson, Goteborg (SE)

(73) Assignee: VOLVO TECHNOLOGY CORPORATION, Goteborg (SE)

(21) Appl. No.: 14/004,433

(22) PCT Filed: Feb. 28, 2012
(86) PCT No.: PCT/SE2012/000021

§ 371 Date: Oct. 24, 2013

Related U.S. Application Data
(60) Provisional application No. 61/452,201, filed on Mar. 14, 2011.

(30) Foreign Application Priority Data
Mar. 14, 2011 (SE) 1100183-1

(51) Int. Cl. F02F 1/24

(52) U.S. Cl. CPC F02F 1/24
USPC 123/193.2

(57) ABSTRACT

A combustion engine includes a combustion engine piston cylinder including an interior wall surface, the interior wall surface having a textured pattern comprising a plurality of texture elements over at least part of an axial length of the interior will surface. An area density and/or a volume of the texture elements of the textured pattern for a given surface area of the interior wall surface and/or a depth of the texture elements increases toward a center of the axial length of the interior wall surface.

The present application claims benefit of U.S. Provisional Application No. 61/452,201, filed Mar. 14, 2011, which is incorporated by reference.

### BACKGROUND AND SUMMARY

The present invention relates generally to combustion engines, and to cylinders and cylinder liners for combustion engines and, more particularly, to combustion engines and cylinders and cylinder liners for combustion engines with a textured pattern on an interior wall surface of the cylinder or cylinder liner.

Of total frictional losses in a combustion engine, approximately 50% can be attributed to the power cylinder unit. The power cylinder unit typically comprises piston rings, piston, piston pin connecting rod and cylinder liner. Reducing frictional losses means reduced fuel consumption and this means reduced CO2 emission.

In the past, the aim of power cylinder system designers has been to reduce the plateau amplitude of the cylinder liner surfaces, or simply put, make surfaces smoother in the region where mechanical contact occurs. Smoother plateau surfaces have several confirmed benefits for the engine such as lower oil consumption, less wear particles in running in phase, etc. Experiments have shown a clear correlation between surface roughness and friction coefficient. It can thus be concluded that plateau roughness governs mechanical friction (a conclusion that experiments suggest is valid for most materials), independent of material property (e.g., hardness, Young's modulus etc.).

There are two types of friction in the engine: mechanical friction (due to mechanical contact (usually metal to metal)); and hydrodynamic (or viscous) friction due to shearing of oil. Most of the engine modifications that have been carried out to reduce friction losses in power cylinder units to date only address mechanical friction. In publications where frictional properties of the power cylinder are analyzed (e.g., experimental tribometer studies), mechanical friction force is almost always the investigated parameter. Of the two friction types (mechanical and hydrodynamic) it is ordinarily the mechanical friction that is studied in tribometer tests.

In summary, most of the current approaches in friction decrease aim at only decreasing mechanical friction. A decrease in the viscosity of oil decreases the average hydrodynamic friction between piston ring/piston and cylinder but increases the average mechanical friction between piston ring/piston and cylinder. Lower viscosity of oil decreases the average hydrodynamic friction between piston ring/piston and cylinder but increases the average mechanical friction between piston ring/piston and cylinder. A decrease in the overall plateau roughness of the cylinder liner decreases the average mechanical friction between piston ring/piston and cylinder but increases the average hydrodynamic friction between piston ring/piston and cylinder.

The inventor has recognized surprising findings resulting from experiments relating to frictional losses in comparing results from pilot tribometer testing and engine testing. In these experiments, to minimize the total friction losses, there was an emphasis on minimizing the mechanical friction losses. The results of the experiments showed that one type of cylinder liner (cylinder liner A) exhibited low mechanical frictional losses (significantly lower compared to baseline cylinder liner) in tribometer tests; the same type of cylinder liner exhibited high fuel consumption (significantly higher compared to baseline cylinder liner). No wear was detected on cylinder liner A, however, wear was detected on the baseline cylinder liner. On evaluating these results the inventor has concluded that the increase in fuel consumption is an effect of increased hydrodynamic frictional losses for cylinder liner A and has also concluded that the hydrodynamic friction has a significant contribution to the total friction.

A paper by Oki Sato et al, Improvement of Piston Lubrication in a Diesel Engine by Means of Cylinder Surface Roughness, SAE International 2004 SAE World Congress (Mar. 8-11, 2004) (“Publication SAE 2004-01-0604”) addresses the issue of frictional optimization of the power cylinder system. All frictional forces that affect the cylinder liner (piston and piston rings) are measured in this setup. In one of the tests a rough surface is compared to a smooth surface (see FIGS. 6 and 7, both reproduced from FIG. 5 of Publication SAE 2004-01-0604). The smooth surface has much lower friction at top dead center (TDC) but the rougher surface has lower friction at mid stroke (at all locations of mid-stroke: −270, −90, 180 and 270 crank angle degrees). Note that these figures show friction force. If friction torque was the result the torque difference would be much larger for mid stroke compared to the difference seen in frictional force. The result of the measurement is friction force, however, it is not friction force that affects fuel consumption, it is friction torque. In simple terms torque is force multiplied by the length of the lever arm, here, the lever arm is the main bearing offset on the crank axis. As the main bearing rotates the distance of the lever arm will reach zero at reversal zones of the piston and will reach maximum length at mid stroke. This means that the frictional torque is always zero at top dead center TDC and bottom dead center BDC. The frictional torque is in this respect more an indicator of hydrodynamic friction rather than mechanical friction.

The inventor contemplates minimizing hydrodynamic friction losses without an increase of the mechanical friction losses. Simply put, the inventor has concluded that, if a cylinder liner has a rougher surface at mid stroke, the hydrodynamic losses will decrease. The inventor has further concluded, however, that it is not merely a matter of making the surface rougher; it should be made rougher in a specific manner.

It is desirable to provide a combustion engine with reduced friction losses. It is further desirable to reduce friction losses in a combustion engine in a way that can involve relatively low cost. It is further desirable that the introduction of a component modification having as its purpose the reduction of friction does not increase wear.

According to an aspect of the present invention, a combustion engine comprises a combustion engine piston cylinder comprising an interior wall surface, the interior wall surface having a textured pattern comprising a plurality of texture elements over at least part of an axial length of the interior wall surface, wherein a volume of the texture elements of the textured pattern for a given surface area of the interior wall surface increases toward a center of the axial length of the interior wall surface.

According to another aspect of the present invention, a combustion engine comprises a combustion engine piston cylinder comprising an interior wall surface, the interior wall surface having a textured pattern of texture elements over at least part of an axial length of the interior wall surface, wherein a depth of the elements increases toward a center of the axial length of the interior wall surface.

According to another aspect of the present invention, a cylinder liner for a combustion engine piston cylinder comprises an interior wall surface, the interior wall surface having a textured pattern of texture elements over at least part of an axial length of the interior wall surface, wherein a volume of the texture elements of the textured pattern for a given surface area of the interior wall surface increases toward a center of the axial length of the interior wall surface.

According to another aspect of the present invention, a cylinder liner for a combustion engine piston cylinder comprises an interior wall surface, the interior wall surface having a textured pattern of texture elements over at least part of an axial length of the interior wall surface, wherein a depth of the texture elements increases toward a center of the axial length of the interior wall surface.

According to another aspect of the present invention, a combustion engine piston cylinder comprises an interior wall surface, the interior wall surface having a textured pattern of texture elements over at least part of an axial length of the interior wall surface, wherein a depth of the elements increases toward a center of the axial length of the interior wall surface.

According to another aspect of the present invention, a combustion engine piston cylinder comprises an interior wall surface, the interior wall surface having a textured pattern of texture elements over at least part of an axial length of the interior wall surface, wherein a volume of the texture elements of the textured pattern for a given surface area of the interior wall surface increases toward a center of the axial length of the interior wall surface.

According to another aspect of the present invention, a combustion engine piston cylinder comprises an interior wall surface, the interior wall surface having a textured pattern of texture elements over at least part of an axial length of the interior wall surface, wherein a depth of the texture elements increases toward a center of the axial length of the interior wall surface.

According to another aspect of the present invention, a combustion engine comprises a combustion engine piston cylinder comprising an interior wall surface, the interior wall surface having a textured pattern comprising a plurality of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

According to another aspect of the present invention, a cylinder liner for a combustion engine piston cylinder comprises an interior wall surface, the interior wall surface having a textured pattern of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

According to another aspect of the present invention, a combustion engine piston cylinder comprises an interior wall surface, the interior wall surface having a textured pattern of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

### BRIEF DESCRIPTION OF THE DRAWINGS

The features and advantages of the present invention are well understood by reading the following detailed description in conjunction with the drawings in which like numerals indicate similar elements and in which:

FIGS. 1A and 1B are schematic views of a combustion engine according to aspects of the present invention;

FIG. 2A and FIG. 2B are plan views of a depression or closed void and a portion of a depression or closed void according to an aspect of the present invention;

FIG. 3A is a plan view of a portion of an interior wall surface of a cylinder or cylinder liner according to an aspect of the present invention;

FIG. 3B is a partially cross-sectional view of a portion of an interior wall surface of a cylinder or cylinder liner according to an aspect of the present invention;

FIG. 4 is a schematic view of a combustion engine according to another aspect of the present invention;

FIG. 5 is a schematic view of a combustion engine according to yet another aspect of the present invention;

FIG. 6 is a graph comparing friction on a rough surface and a smooth surface;

FIG. 7 is an enlarged view of one of the graphs in FIG. 6;

FIG. 8 is a schematic, side, partially cross-sectional view of a tribometer of the general type used to test reference and test sample surfaces;

FIG. 9 is a table showing the design of experiment (DoE) used for testing reference and test sample surfaces;

FIG. 10 is a graph showing how average maximum diameter, grain density/area density of texture elements, average grain area, and average minimum diameter compared for reference and test samples;

FIG. 11 is a graph showing how average orientation, average perimeter, and average depth compared for different reference samples;

FIG. 12 is microphotograph of a surface of a reference surface (left) and a textured surface (right);

FIG. 13 is two microphotographs of a textured sample, one of which (left) focuses on the bottom of a texture element and shows wear particles trapped therein, and one of which (right) focuses on the plateau above the texture element;

FIG. 14A is a graph of oil dynamic viscosity during testing of samples, FIG. 14B is a graph of sliding speed during testing of samples, and FIG. 14C is a graph of contact pressure on samples during testing;

FIGS. 15A, 15B, and 15C are graphs showing the measured friction coefficient for all tests (except for those samples that were removed) on reference and textured samples;

FIGS. 16A, 16B, and 16C are graphs showing the resistive coefficient for all tests (except for those samples that were removed) on the reference and textured samples;

FIG. 17A shows the average friction coefficient values for each textured sample surface and the reference surface;

FIG. 17B shows the average resistive coefficient values for each textured sample surface and the reference surface;

FIG. 18 is a table that shows average values of standard deviation of friction coefficient and resistive coefficient for the samples;

FIG. 19 is a graph that shows the average values of friction coefficient for all experiments and DoE cycle steps for each surface type plotted against the average of resistive coefficient for all experiments and DoE cycle steps for each surface type;

FIGS. 20A-20C are graphs of average friction coefficient versus dynamic viscosity for each surface type;

FIGS. 21A-21C are graphs of average friction coefficient versus average sliding speed for each surface type;

FIGS. 22A-22C are graphs of average friction coefficient versus contact pressure for each surface type;

FIG. 23 is a cross-sectional view illustrating the effect of texturing of a surface on oil film thickness in texture elements and on plateaus by texture elements;

FIG. 24 is a graph showing the effect of texturing on oil film thickness on reference surfaces and in texture elements;

FIG. 25 is a graph showing the effect of texturing on oil film thickness on reference surfaces and textured surfaces.

### DETAILED DESCRIPTION

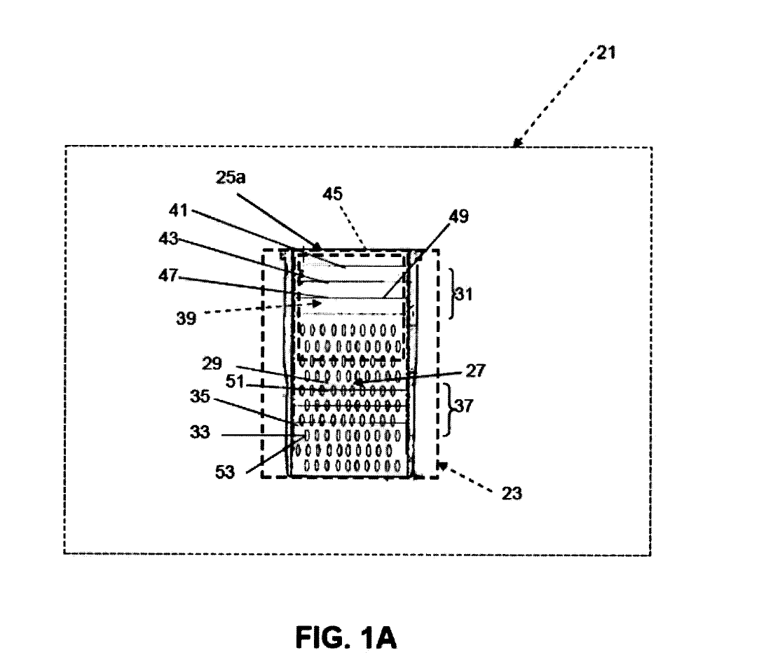

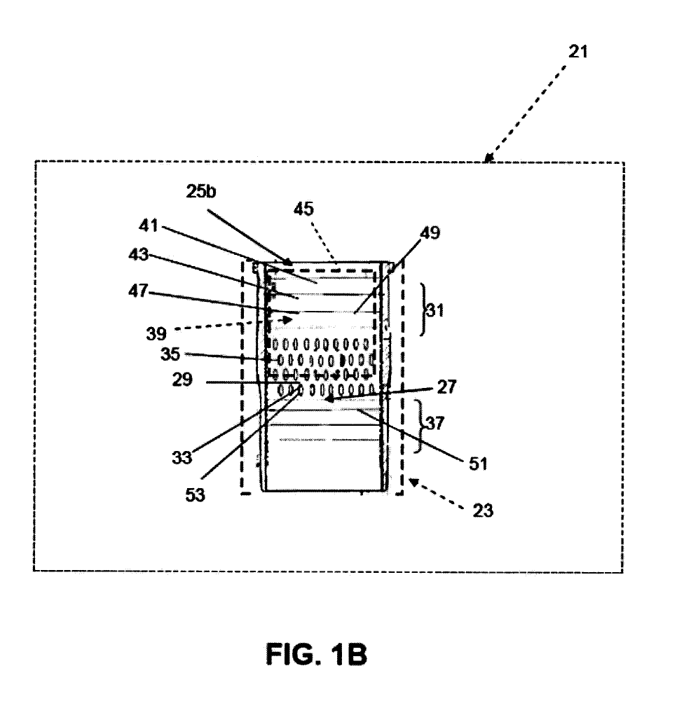

FIG. 1A schematically shows (in phantom) a combustion engine 21 according to an aspect of the present invention. The combustion engine 21 may be a compression ignition or a spark ignition engine or a piston compressor. The combustion engine 21 comprises a combustion engine piston cylinder 23 comprising a cylinder liner 25a according to a further aspect of the present invention. FIG. 1A shows a cross section of the cylinder liner 25a. An alternative name for what is referred to herein as a “cylinder”, as distinguished from a cylinder liner, is a cylinder bore. Where a cylinder comprises a cylinder liner, the cylinder liner is disposed in the cylinder bore.

The cylinder liner 25a comprises an interior wall surface 27. The interior wall surface 27 has a textured pattern 29 over at least part of an axial length of the surface, usually at least below a top reversal zone 31. If a cylinder liner is not provided, the cylinder 23 may be provided with the textured pattern 29. The invention is described and illustrated herein in terms of a cylinder liner with a textured pattern 29, however, it will be appreciated that the references to a cylinder liner with the textured pattern apply equally to a cylinder with the textured pattern, except where otherwise noted.

The expression “textured pattern” is expressly defined for purposes of the present invention as a regular, repeated pattern of distinct elements (typically in the form of depressions) 33 such as depressions in the form of closed voids or grooves in the interior wall surface 27, the substantial remainder of the interior wall surface 27 being defined by what shall be referred to here as one or more plateaus 35 radially inward of the elements 33, the elements 33 and plateaus 35 forming a texture, where inward is defined for purposes of the present application as meaning closer to the longitudinal axis of symmetry of the cylinder 25a (or cylinder 23). Other, more irregular and generally more microscopic depressions may define other, more irregular and generally more microscopic plateaus as is well known in the art, however, depressions and plateaus of that type are not of substantial interest with respect to this aspect of the present invention. The textured pattern 29 can be provided in any suitable way, such as by being machined via a milling, turning, or drilling operation, via chemical etching, water-jet cutting, abrasive blasting, or hydro-erosive grinding, or some combination of such operations.

The interior wall surface 27 may also have a textured pattern 29 over an axial length of the surface, usually above a bottom reversal zone 37 as seen in the cylinder liner 25b shown in cross-section in FIG. 1B. Ordinarily, it is desirable to provide a textured pattern 29 at least on portions of the interior wall surface 27 below the top reversal zone 31, however, generally speaking it is considered to be desirable to provide the textured pattern at least on the part of the cylinder liner (or cylinder) where viscous friction tends to dominate, as opposed to mechanical friction. The top reversal zone 31 is defined for purposes of the present invention as an axial distance starting from the top of the cylinder liner 25a, 25b (or cylinder) down to the turning point or TDC (Top Dead Center) 49 of the lowest piston ring (in the FIGS. this ring is an oil ring 47) with—by way of an example—an addition of substantially 2% of stroke length. To illustrate by way of an example, if the stroke length is substantially 150 mm, the top reversal zone 31 will end substantially 3 mm below the TDC 49 of the lowest piston ring (in the FIGS. the oil ring 47). The lower reversal zone 37 is hereby defined as an axial distance starting from the bottom of the cylinder liner 25a, 25b up to the turning point or BDC (Bottom Dead Center) 51 of the highest piston ring (in the FIGS. this is a top piston ring 41) with—by way of an example—substantially an additional 2% of stroke length. To illustrate by way of an example, if the stroke length is substantially 150 mm, the lower reversal zone 37 will end substantially 3 mm above BDC 51 of the highest piston ring (in the FIGS. the top piston ring 41).

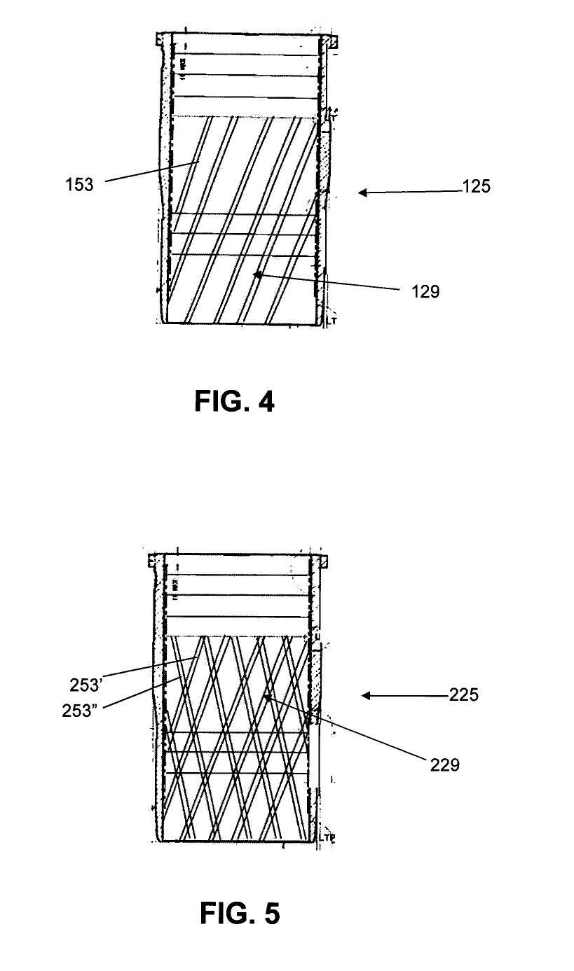

The inventor has recognized that a significant part of the total friction losses in a power cylinder unit are viscous friction losses, and has discovered that a reduction of the viscous losses is very beneficial for reduction of fuel consumption and CO2 emission. The textured pattern 29 facilitates an increase in the oil film between the cylinder liner 25a, 25b (or cylinder) at the locations of the texture elements and a piston 39 (or top piston ring 41, second piston ring 43, or oil ring 47) in order to minimize hydrodynamic (viscous) friction losses. Horizontal lines in the top and bottom reversal zones 31 and 37 in FIGS. 1A and 1B represent approximate TDC (Top Dead Center) and BDC (Bottom Dead Center) for the rings 41, 43, and 47 (in FIGS. 4 and 5, similar, unnumbered horizontal lines representing TDC and BDC for rings of a piston (not shown in FIGS. 4 and 5) are provided). In FIGS. 1A and 1B the piston 39 is schematically illustrated in phantom at the upper end of the cylinder liner 25a and 25b as a square. The part of the cylinder liner 25a, 25b (or cylinder) where viscous friction tends to dominate is the majority of the stroke of the piston 39, excluding the reversal zones 31 and 37. The thickness of the oil film tends to increase with speed of the piston 39, and speed of the piston 39 tends to be greater as distance from the reversal zones 31 and 37 increases. It is presently contemplated that it will be optimal for the textured pattern 29 to form one or more plateaus 35 so a textured area is between substantially 5-50% of a total area of the at least part of the axial length of the interior wall surface 27 having the textured pattern 29 and so that what shall be referred to as an untextured area is between substantially 50-95% of a total area of the at least part of the axial length of the interior wall surface having the textured pattern, although it may be desirable to have that range expanded in certain circumstances. A substantial benefit advantage of an aspect of this invention is that it has the potential to lower the hydrodynamic friction losses without any noticeable increase of the mechanical friction losses.

A further benefit of providing the textured pattern 29 is that wear on the piston 39, piston rings (41, 43, 47), and cylinder liner 25a or 25b (or cylinder 23) can be reduced because debris can be retained in the textured pattern 29. The surface texturing of the interior wall surface 27 of the cylinder liner 25a, 25b (or cylinder 23) could, however, in some circumstances, increase the wear levels due to the fact that there will be less oil film (and probably more mechanical contact) separating the surfaces. However, it is also possible that the wear levels could decrease. The majority of the wear of the cylinder liner 25a, 25b is due to three-body-abrasion. It is expected that sufficiently deep elements 33 could trap wear particles and decrease wear of the cylinder liner 25a, 25b. Particle trapping and reduction of viscous friction losses via textured patterned surfaces could also be applied on other components, such as at small or large ends of the connecting rod, the piston pin, the piston (in this case the part of the piston that supports the piston pin) or the main bearings.

The piston 39 shown in FIGS. 1A and 1B has a top ring 41, a second ring 43 further from a top 45 of the piston 39 than the top ring 41, and an oil ring 47 furthest from the top 45 of the piston 39. The textured pattern 29 will ordinarily be disposed axially below top dead center (TDC) 49 of the oil ring 47. The textured pattern 29 may be disposed axially above a bottom dead center (BDC) 51 of the top ring 41. The textured pattern 29 is ordinarily put on the portion of the cylinder liner 25a or 25b where the Hersey number is high which, in principal, means that the texturing will ordinarily not be provided at least on any part of the top reversal zone 31 of the three rings, it being understood that the texturing may not be provided on any part of the bottom reversal zone 37 as well. Even though the Hersey number of second ring 43 and the oil ring 47 is ordinarily relatively high in the vicinity of CTDC (Combustion Top Dead Center), at least in comparison to the Hersey number of the top ring, temperature at this point tends to be quite high which in turn will ordinarily make the contact situation severe. The Hersey number specifies the severity of the tribological contact. The Hersey parameter is defined as:

Hv=(v*η)/P. (1)

where:

v is velocity (of a moving part, e.g. piston ring)

η is dynamic viscosity (of oil)

P is contact pressure (exerted e.g. between a piston ring and a cylinder liner or cylinder)

In reversal zones, Hv is low. In mid-stroke Hv is high. Velocity v has great significance for this parameter, and the velocity v is zero at turning points and maximal at mid stroke). The inventor has recognized that, because Hv is close to zero in the reversal zones 31 and 37 where the velocity v of the piston 39 is low, it is more important to avoid contact and it is therefore desirable to have an oil film present to avoid wear and/or seizure. Therefore, the inventor has recognized the desirability of providing an interior wall surface 27 as shown in FIG. 1B, with a textured pattern 29 only below the top reversal zone 31 and above the bottom reversal zone 37.

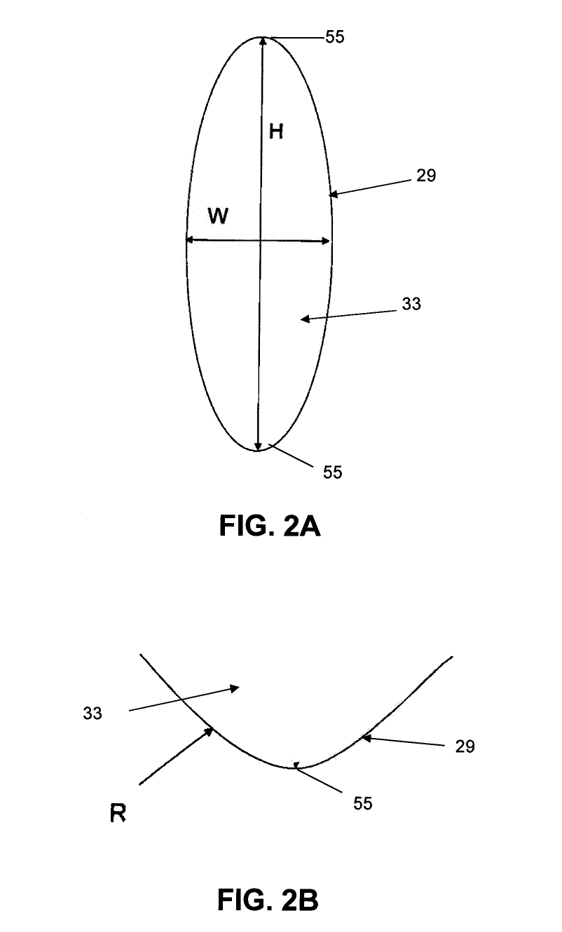

FIGS. 1A and 1B show cylinder liners 25a and 25b wherein the textured pattern 29 comprises elements 33 in the form of a plurality of depressions or closed voids 53 (hereinafter generally referred to as “depressions”). The geometrical form of the depressions 53 can be described by an axial height H (FIG. 2A) and a width W (FIG. 2A) within the interior wall surface 27 of the cylinder liner 25a, 25b (or cylinder) and a depth radially outward of the interior wall surface 27 of the cylinder liner 25a, 25b (or cylinder). A minimum axial height H (FIG. 2A) of the depressions 53 will ordinarily be greater than a predetermined percentage of the stroke length. It is presently believed that a desirable percentage of the stroke length for the minimum axial height H of the depressions 53 is equal to about 0.33 percent of the stroke length, i.e., the stroke length divided by 300. For example, in the MD13 engine, available from Volvo Lastvagnar AB, Goteborg, Sweden, the piston has a stroke length of 158 mm, and a minimal axial length of a texture would be about 0.5 mm. Ordinarily, the axial height H of the depressions 53 is between substantially 300-6000 μm. A minimum width W (FIG. 2A) of the depressions 53 is also ordinarily between substantially 300-6000 μm. A depth of the depressions 53 is ordinarily between substantially 20-200 μm. In a presently preferred embodiment, a minimum depth of the depressions 53 is substantially equal to 35 μm. While it is presently believed that providing textures or depressions 53 with depths less than 35 μm, such as around 20 μm, may, in some circumstances provide beneficial results, in some circumstances textures or depressions with depths around 30 μm may actually increase friction, and it is presently believed that textures or depressions of at least 35 μm and, likely, substantially greater than 35 μm will provide most beneficial results.

In the embodiment of the cylinder liner 25a or 25b shown in FIGS. 1-3, the depressions 53 each have one of a substantially circular, oval, or elliptical shape. It will be appreciated, however, that the depressions can have other shapes, such as triangular, square, diamond, etc. In the embodiment shown in FIGS. 1-3, the depressions 53 each have radiused ends 55 at opposite axial ends of the depressions 53. FIG. 2B shows that the ends 55 can have any desired radius R.

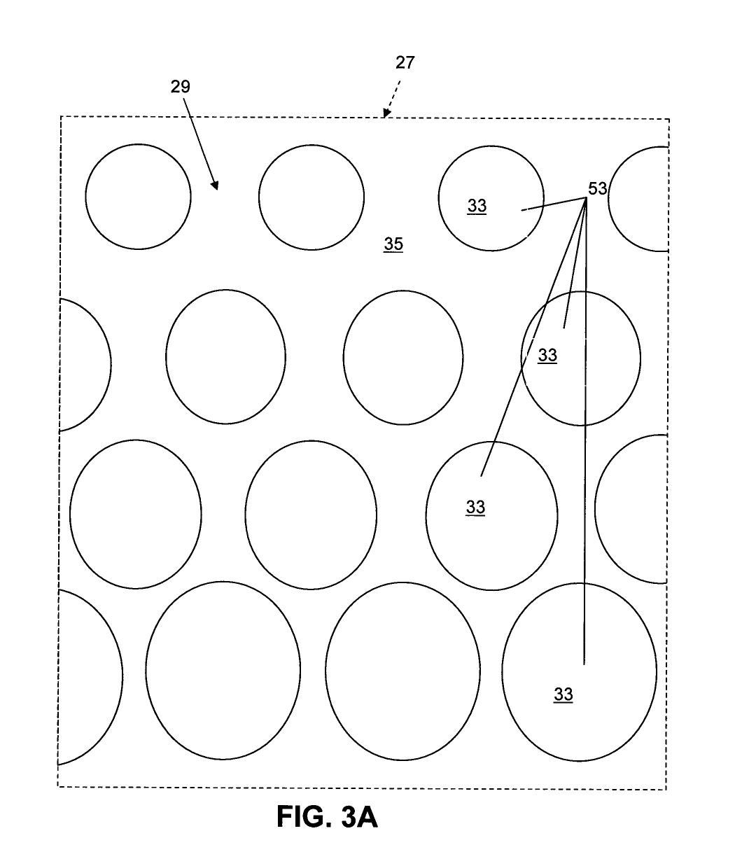

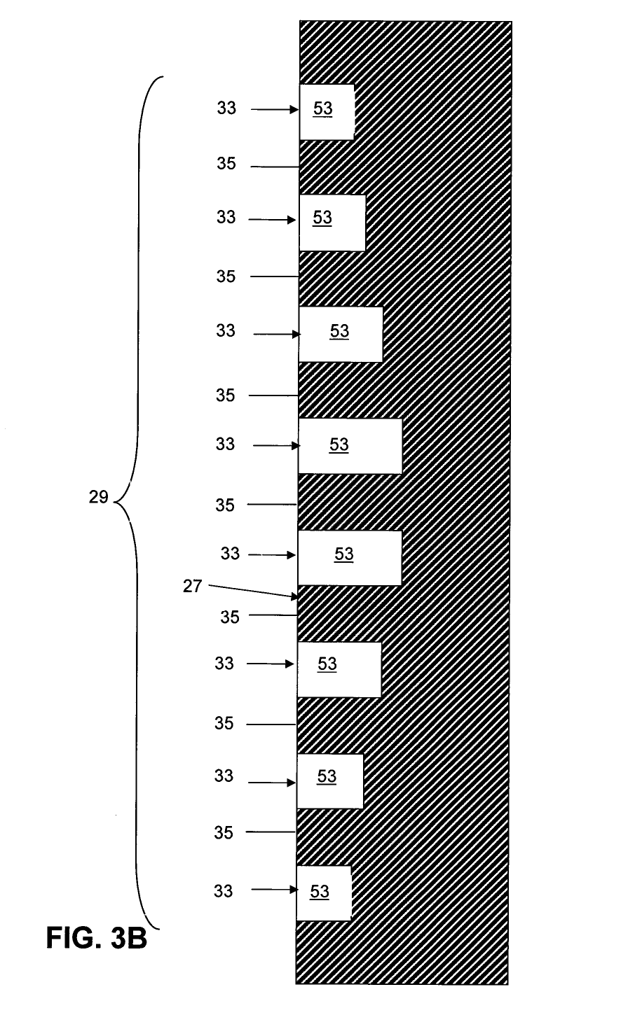

As seen in the portion of the interior wall 27 of the cylinder liner or cylinder shown in FIG. 3, a patterned texture 29 with elements 33 in the form of depressions 53 and essentially a single plateau 35 separating the elements 33 from each other, a volume of the depressions 53 can increase toward a center of the axial length of cylinder or cylinder liner. The speed of the piston 39 is ordinarily greatest toward the center of the axial length of the cylinder or cylinder liner and, consequently, the oil film thickness tends to be greatest toward the center of the axial length of the cylinder or cylinder liner. By increasing the volume of the depressions 53 individually and/or by increasing the volume of the depressions in a given area toward the center of the axial length of the cylinder or cylinder liner, the oil film in the texture elements of the cylinder or cylinder liner can be increased and viscous friction losses can thus be reduced. The volume of the individual depressions 53 can be increased toward the center of the axial length of the cylinder or cylinder liner by making the depressions 53 longer, wider, or deeper, or some combination of two or more of those characteristics. FIG. 3A shows—as an example—that the depressions 53 become longer and wider and more elliptical in their contour toward a center of the cylinder liner. The depressions 53 in FIG. 3A will ordinarily increase in depth but they may remain the same depth and still increase in individual volume toward the center of the axial length of the cylinder or cylinder liner. FIG. 3B shows—as another example—that the depressions become deeper yet of the same diameter toward a center of the cylinder liner and thereby increase in volume individually toward the center of the axial length of the cylinder or cylinder liner. The depressions 53 may also become deeper and larger or smaller in their axial and circumferential dimensions while still individually increasing in volume toward the center of the axial length of the cylinder or cylinder liner. The volume of the depressions in a given area can be increased by increasing one or more of the height, width, or depth of the depressions, and/or by increasing the number of depressions in a given area.

In addition, the area density of the texture elements of the textured pattern for a given surface area of the interior wall surface can vary over the axial length of the cylinder or cylinder liner, usually by increasing toward a center of the axial length of the surface, by increasing at least one of a height and width of the texture elements, such as the depressions 53 seen in FIG. 3A, per unit area toward the center of the axial length of the interior wall surface. If the height or width of the texture elements is varied, the depth can also be varied, usually by increasing depth toward the center of the axial length of the interior wall surface. Area density can also be varied by varying quantity of texture elements in a given area.

Presently, it is contemplated that it is most preferable to increase the volume of the depressions individually and in a given area by increasing their depth closer to the center of the axial length of the cylinder or liner. To the extent that the height H and width W of the depressions 53 is different, the depressions 53 will ordinarily have a maximum dimension extending in an axial direction of the cylinder liner 25a, 25b of the cylinder 23 (FIG. 1A or 1B), however, the depressions may alternatively have a maximum dimension in a tangential direction of the cylinder (i.e., width W of the depressions 53 may be greater than height H).

FIGS. 4 and 5 show alternative embodiments of textured patterns 129 and 229.

FIG. 4 shows an embodiment comprising a textured pattern 129 with texture elements in the form of a plurality of what shall be referred to as substantially parallel grooves 153, it being appreciated that the grooves may be somewhat helical in shape. The grooves 129 ordinarily form a non-zero angle with a longitudinal axis of the cylinder liner 125 (or cylinder). The grooves may vary in volume and/or area density over their length, such as by becoming deeper and/or wider toward the center of the length of the liner or cylinder.

FIG. 5 shows an embodiment wherein the textured pattern 229 comprises elements in the form of a first and second plurality of substantially parallel grooves 253′ and 253″ that form first and second, non-zero angles with the longitudinal axis of the cylinder liner 225 (or cylinder), the second angle being different than the first angle. In the illustrated embodiment, the first angle and the second angle are substantially equal, but opposite angles.

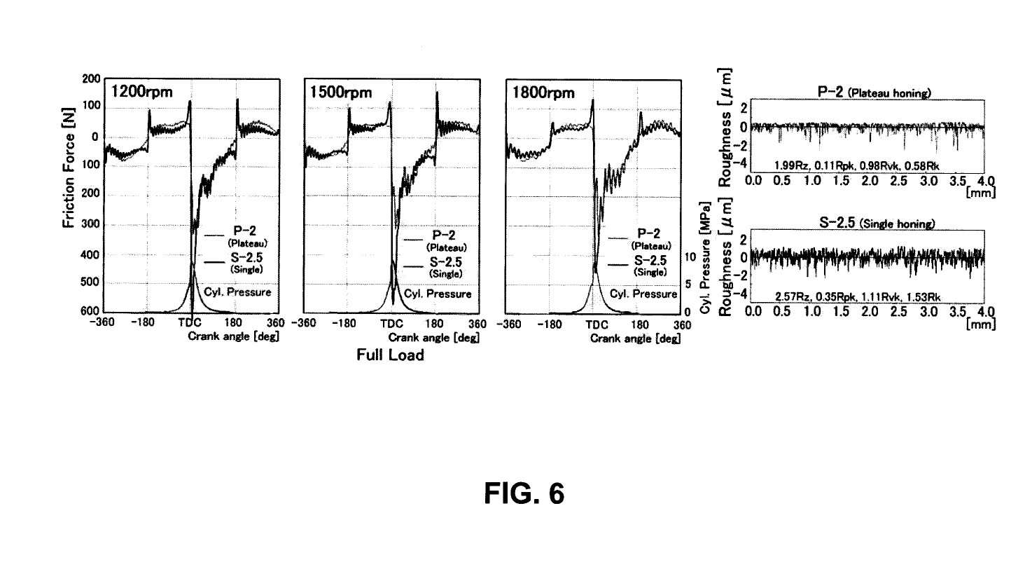

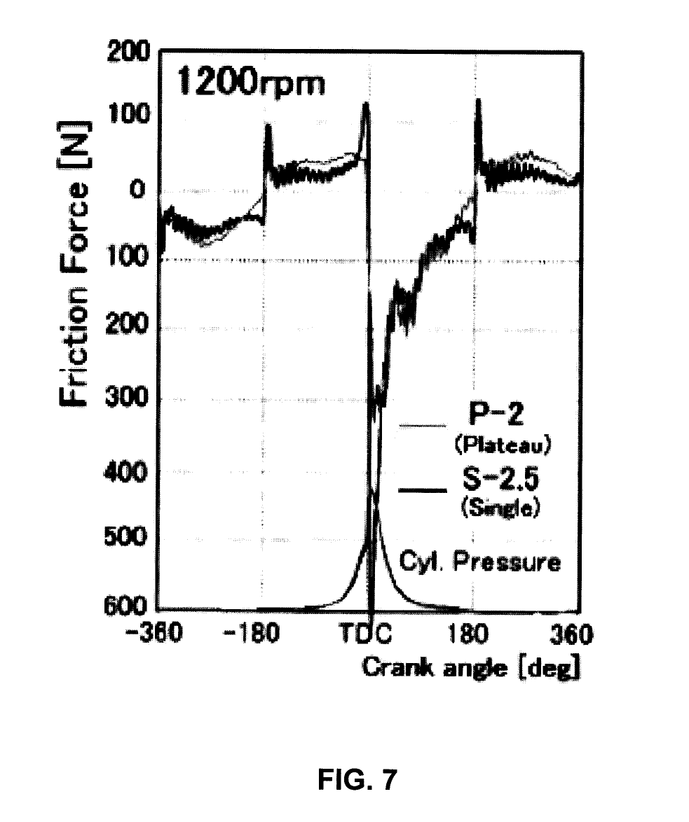

FIGS. 6 and 7 are graphs of tests for friction in cylinder liners with a rough surface and a smooth surface, respectively (both reproduced from FIG. 9 of Publication SAE 2004-01-0604). The smooth surface has much lower friction force at top dead center (TDC) but the rougher surface has lower friction force at mid stroke (at all locations of mid-stroke: −270, −90, 180 and 270 crank angle degrees). If friction torque is considered, the torque difference would be much larger for mid stroke compared to the difference seen in frictional force. A large frictional force at TDC does not have an impact on the frictional torque. The frictional torque is in this respect more or less only an indicator of hydrodynamic friction. By reducing friction at mid-stroke as in aspects of the present invention, substantial gains in reduction of friction torque can be achieved.

### I. Testing Procedure

An investigation was performed to test the inventor's theories regarding reduced hydrodynamic friction resulting from provision of texture elements on the interior surface of a cylinder or cylinder liner, particularly regarding the benefits of increasing depth of texture elements toward a center of the axial length of the cylinder or cylinder liner.

A. Milling of Textures

A five axis computer controlled milling machine was used to produce the texturing pattern. Milling was performed directly on cylinder liner specimens because the chosen milling operation requires line of sight to the machined surface. The milling operation in which a flat ended tool was used gave a sharp angle at the boundary of the texture, having this high angle is different from other texturing techniques. Two different texture element depths were machined; 20 μm and 100 μm (termed T20 and T100 further on in the document), both textures had the same elliptical shape with the minor axis being 2 mm and the major axis being 3 mm. Four reference samples REF-1, REF-2, REF-3 and REF-4, four textured samples with texture element depths of 20 μm T20-1, T20-2, T20-3, T20-4, and four textured samples with texture element depths of 100 μm T100-1, T100-2, T100-3, and T100-4 were produced.

B. Removal of Sharp Edges

The milling operation caused sharp edges or “burrs” at the boundary of each texture element. Because this defect causes additional wear particles it was decided to remove the sharp edges before the experiments. By running each sample for five minutes using the experimental input parameters Temperature 33° C., reciprocating frequency 14 Hz, and load 22 N (the center point of what is later referred to herein as the “DoE setup”) the burrs were effectively removed. This running in stage was carried out using oil control rings and engine oil that were not used in further experimentation. The running-in stage was performed on all samples, both textured and un-textured.

C. Tribometer Test Setup

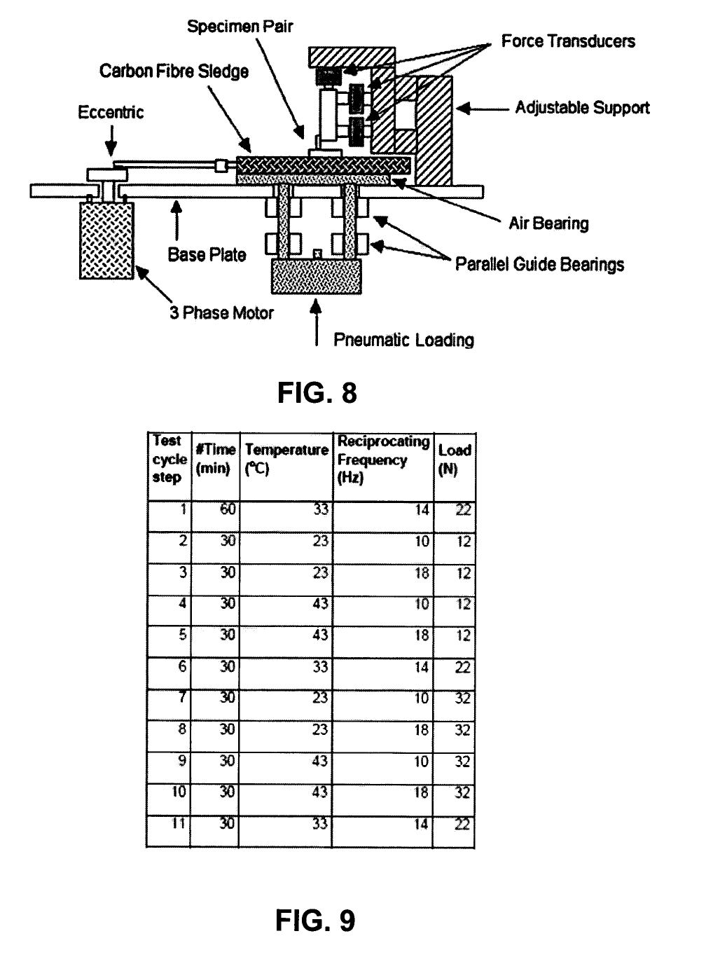

A tribometer test setup was used to quantify the frictional properties of reference and textured surfaces. A schematic overview of the tribometer is shown in FIG. 8. In the tribometer experiment oil was continuously fed from the piston ring sample holder to the inner diameter of the oil control ring and into the gap between the two beams in the oil control ring. The oil was supplied using a peristaltic pump, 4.8 ml/min was continuously supplied during the duration of the experiment. The oil was directly fed to the region of contact between the piston ring and the cylinder liner, which was accomplished by feeding oil from the piston ring sample holder in the direction from the inner diameter of the oil control ring. This ensured a fully flooded ring at all test conditions. The oil used was fully formulated 20W50 engine oil. The stroke length in the tribometer was set to 30 mm.

D. Reference and Textured Test Surfaces

In the tribometer, the reference cylinder liner surface, REF, and two different textured surfaces, T20 and T100, were evaluated. The opposing surface was a coil spring loaded two piece oil control ring with two beams and standard beam width between 200 μm and 300 μm. The tribometer experiment was repeated four times for each surface. The input signals in the experiment were reciprocating frequency, temperature and load; these signals were varied according to a Design of Experiment (DoE) setup (FIG. 9) with high and low levels of all three input parameters. To verify the stability of the experiment over time three center points, as starting point, center of experiment duration and at the end of the DoE setup, were also added to the DoE setup. The measured output parameters were: friction force and contact resistivity. More details of the experimental setup and quantification of input and output signals can be found in S. Johansson et al., Experimental friction evaluation of cylinder liner/piston ring contact. Wear 271 (2011) 625-633; S. Johansson et al., Frictional evaluation of thermally sprayed coatings applied on the cylinder liner of a heavy duty diesel engine: Pilot tribometer analysis and full scale engine test. Wear 273 (2011) 82-92; and S. Johansson, P. H. Nilsson, R. Ohlsson, B.-G. Rosen. Simulation and Experimental Analysis of the Contact between Oil Control Ring and Cylinder Liner in a Heavy Duty Diesel Engine. Proceedings of 18th International Colloquium Tribology 10-12 Jan. 2012 Stuttgart/Ostfildern, Germany, both of which are incorporated by reference.

E. Removal of Background Form Effect and Quantification of Wear Depth

Surfaces were measured using CCP (Cromatic Confocal Probe). The complete surface of the cylinder liner sample, 50 mm*10 mm, was measured using a point spacing of 10 μm, the surface was measured before and after the experiment. The influence of the background surface was removed to obtain a representative value of the dimensions of the textures with the following operations:

1. Substitution of missing points by defined smooth shape (used evaluation software from Mountains Map ver 5.1, Product of Digital Surf, Besancon, France)
2. Second order polynomial form removal from original surface measurement.
3. Edge detection technique (grain analysis modulus shape (used evaluation software from Mountains Map ver 5.1, Product of Digital Surf, Besancon, France)) to define edges between the textures and the plateau surface.
4. Extraction of grains, only grains belonging to the texture elements were selected.
5. Masking of the texturing elements using output of grain analysis. The texturing is thus removed from the surface (the datum of the texturing elements was replaced with missing points).
6. Second polynomial form removal on the plateau surface (textures were removed using grain analysis in previous step), output from this step is the 2D form.
7. Subtraction of the surface form generated in 6 with the surface obtained in 2.

Using the computational steps above a surface without form effects relating to the texturing elements was obtained. In order to quantify the wear depth, the surface measured before the experiment was subtracted from the surface measured after the experiment.

F. Texture Geometry—3D Profilometry—Evaluation of Wear and Texture Geometry

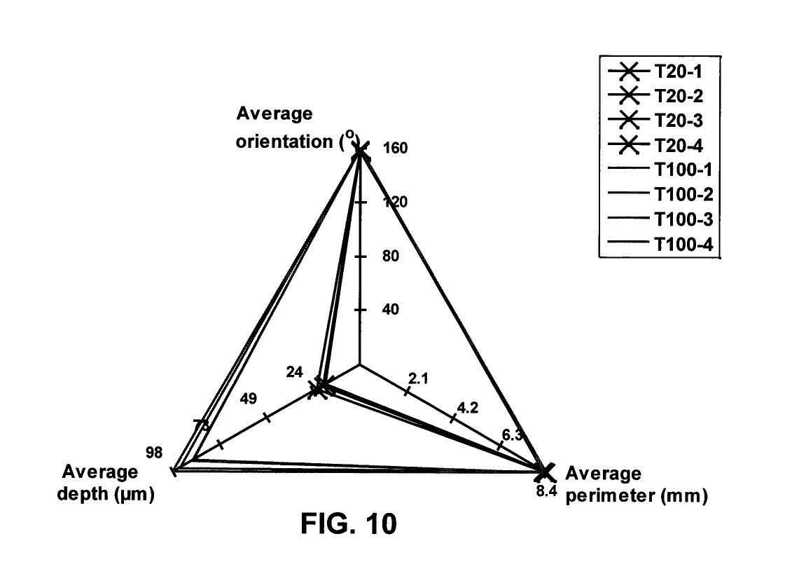

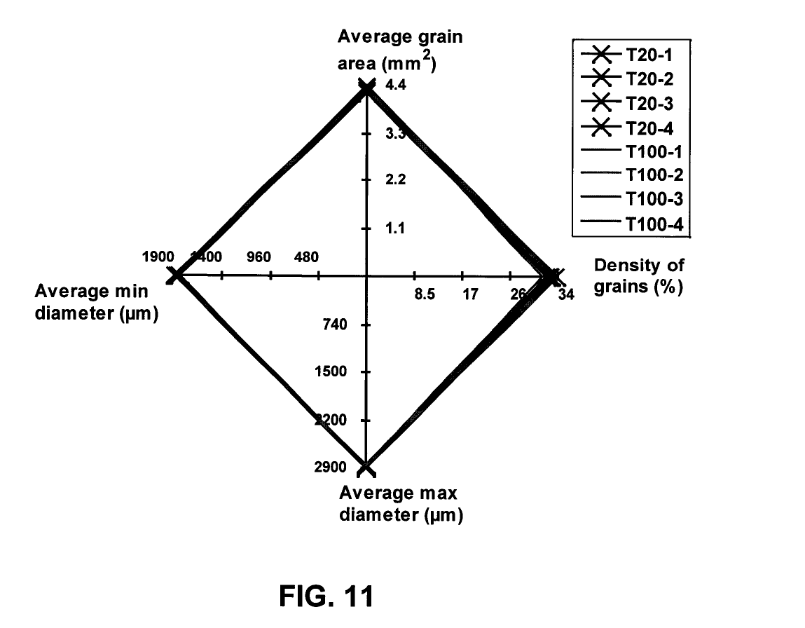

The geometry of the elements forming the texture was evaluated using grain analysis. In the comparison between materials T20 and T100 the only difference in respect to texture geometry was the depth of the textures. As can be seen from FIG. 10, no other significant differences could be detected between the density of textures (also referred to as “grains”), the average maximum and minimum diameter (heights or widths) of the textures, or the average area of the textures. FIG. 11 shows that, for the two textured samples T20 and T00, the average texture orientation (also referred to as “lay” or “surface angle”) and the average texture perimeter are substantially the same.

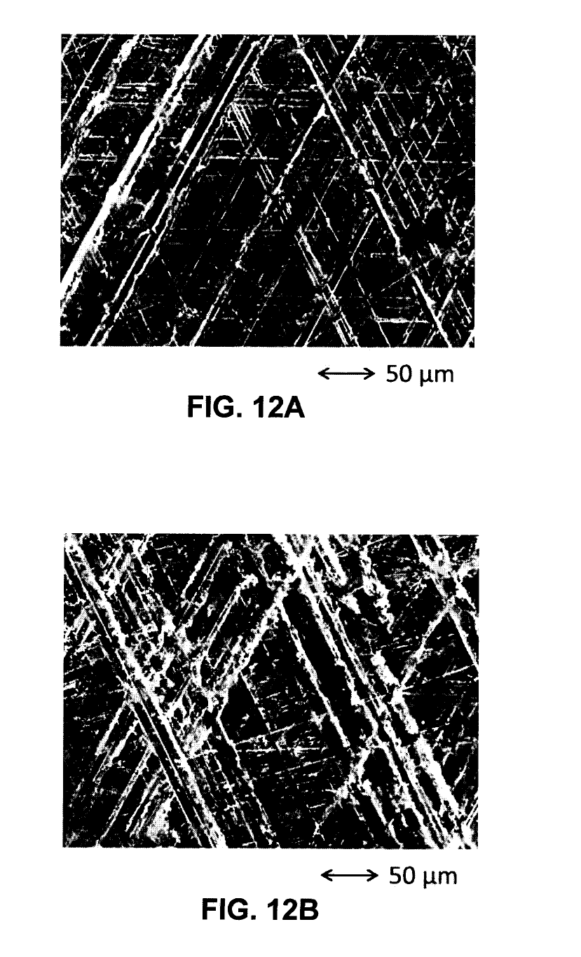

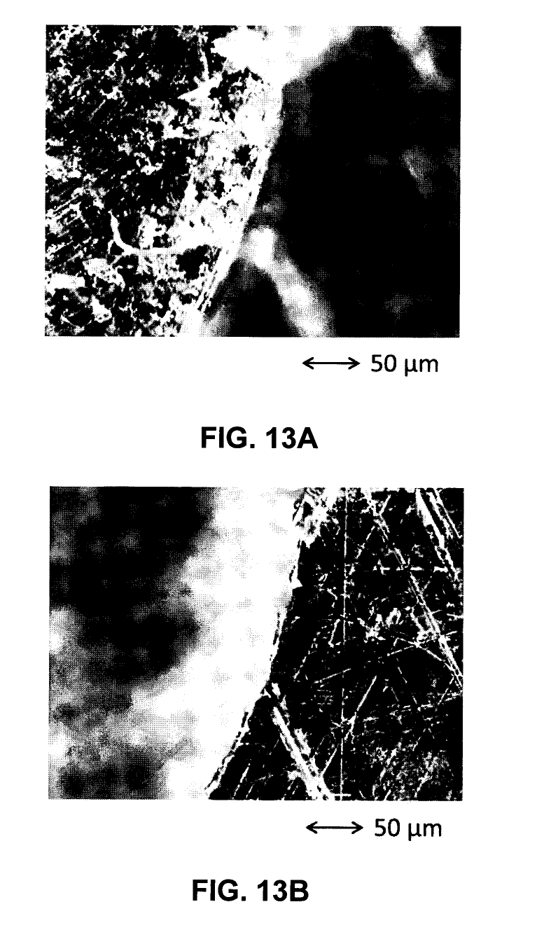

No wear was detected in the evaluation of wear depth (subtraction of surfaces before and after the experiment). However, as an additional analysis of wear, the surfaces were analyzed in light optical microscope after the experiment. In this analysis abrasive scratches were detected on the plateau part of the reference surface. FIG. 12 (left), however, virtually no abrasive scratches were detected on the plateau part of the textured surfaces, i.e. (FIG. 12 (right). In closer inspection in the texture elements it was seen that the textured elements contained significant amounts of wear particles. FIG. 13 shows two views of a T100 sample after the experiment, with the image on the left showing the bottom of a texture element with wear particles trapped therein, and the image on the right focusing on the plateau above the texture element showing expected wear on the boundary of the element, but no significant wear on the neighboring plateau.

G. Tribometer—Evaluation of the Stability of Input Signals

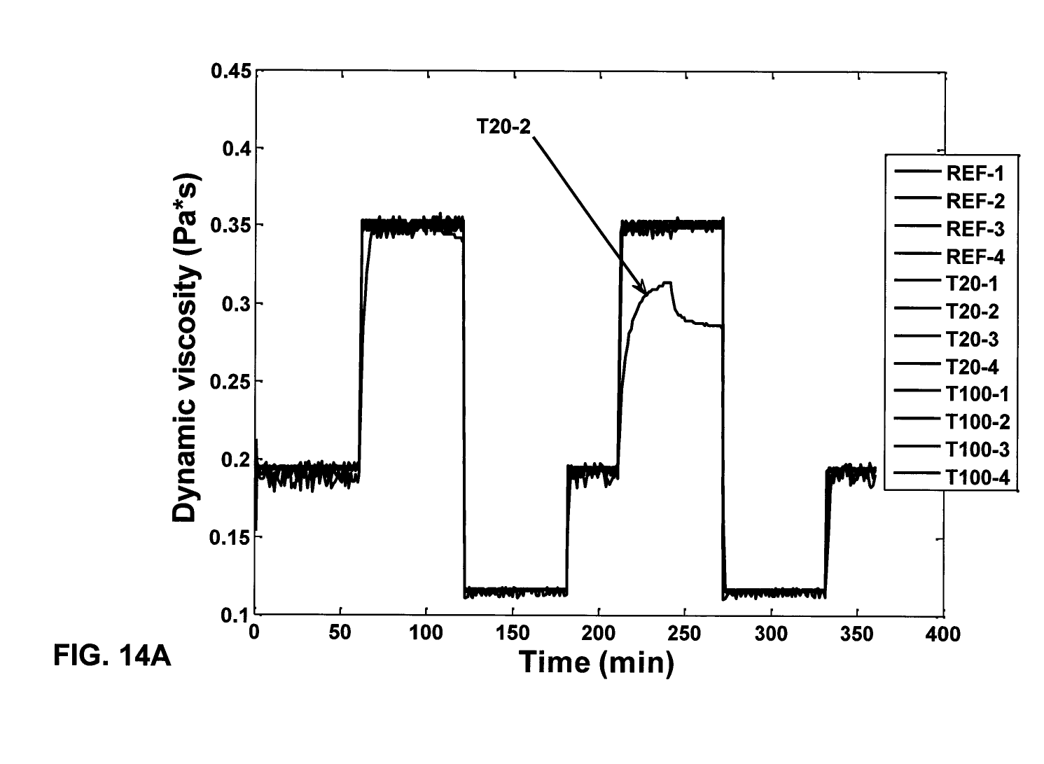

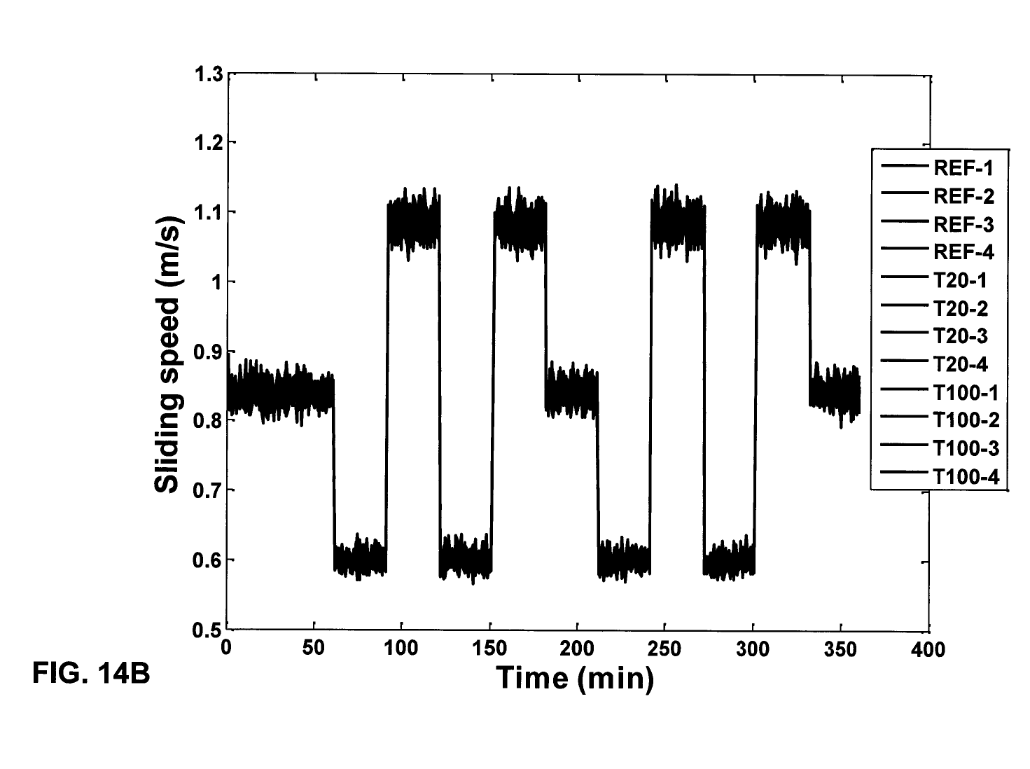

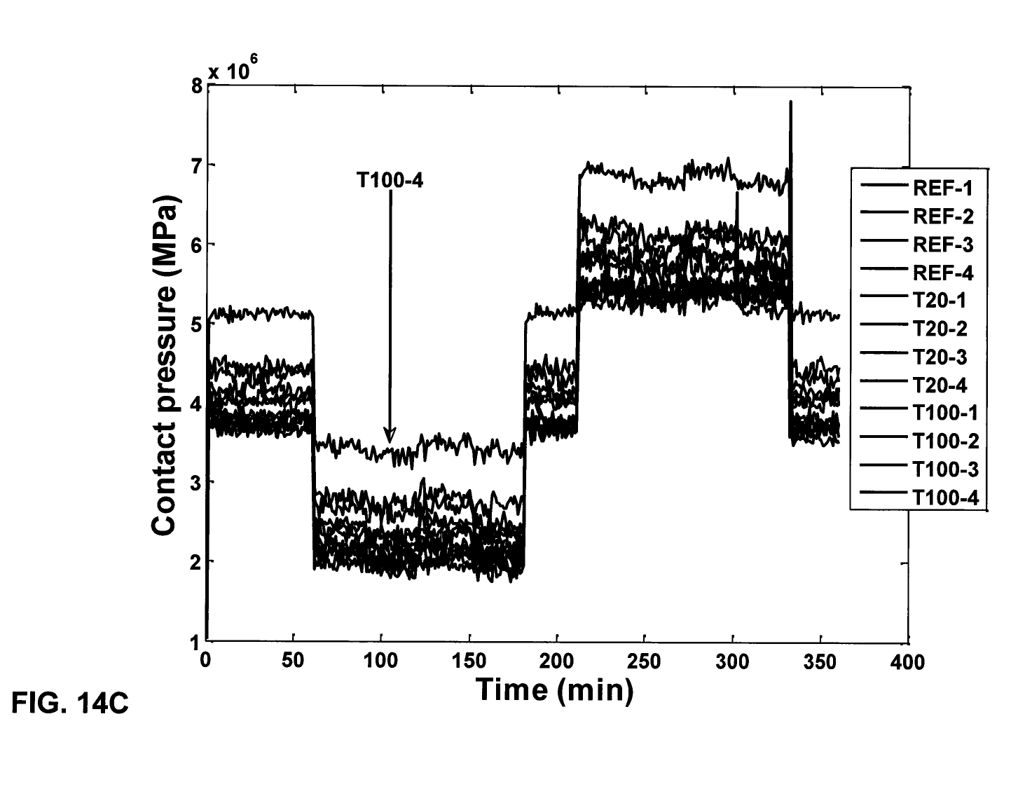

To gain representative values for each surface the validity of the input signals was quantified. To gain better representation of the input signals these input signals were recalculated: oil dynamic viscosity (FIG. 14A) was calculated from temperature; sliding speed (FIG. 14B) was calculated from reciprocating frequency; and contact pressure (FIG. 14C) was calculated from load according to a previous study at S. Johansson et al., Experimental friction evaluation of cylinder liner/piston ring contact, Wear 271 (2011) 625-633, which is incorporated by reference. Performing the recalculation of input parameters also gave parameters which were independent of the test arrangement because sliding speed is dependent on stroke length, contact pressure is dependent on relative area of contact etc.

From analysis of the input signals it was detected that for one of the samples of T20 (T20-2) the dynamic viscosity was different from the other signals and for one of the samples of T100 (T100-4) the contact pressure was different from the other measured signals. These two samples were thus removed in further evaluation. With regard to the samples T20-2 and T100-4 which were removed from this study, it should be noted that both of these samples exhibited smaller values of friction coefficient compared to the average value for each surface type.

H. Tribometer—Evaluation of Friction Coefficient and Resistive Coefficient

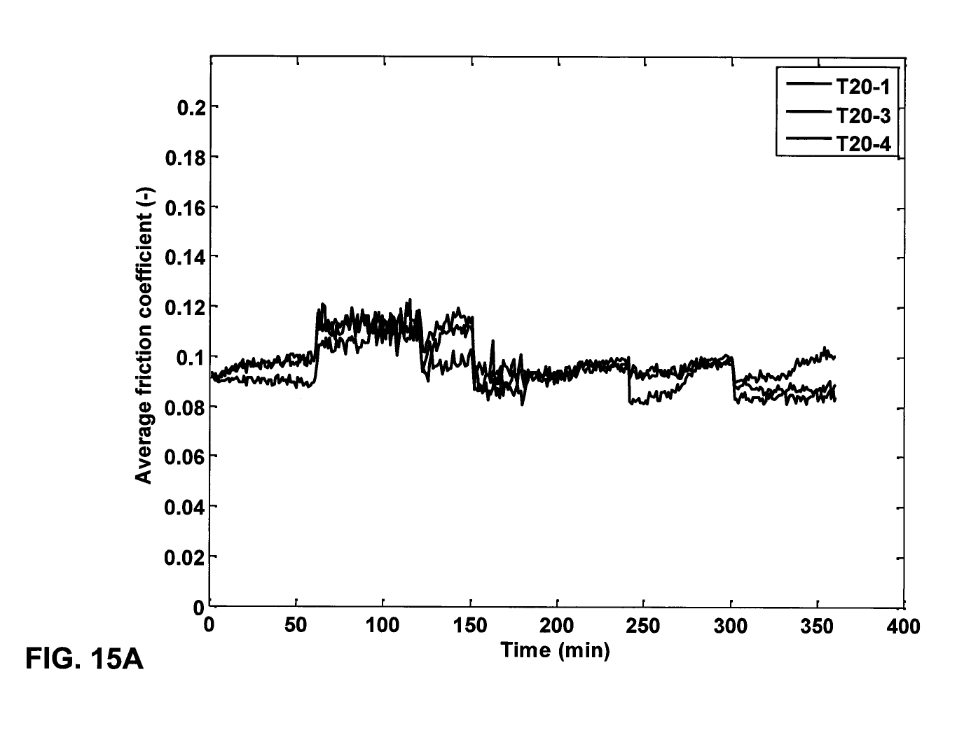

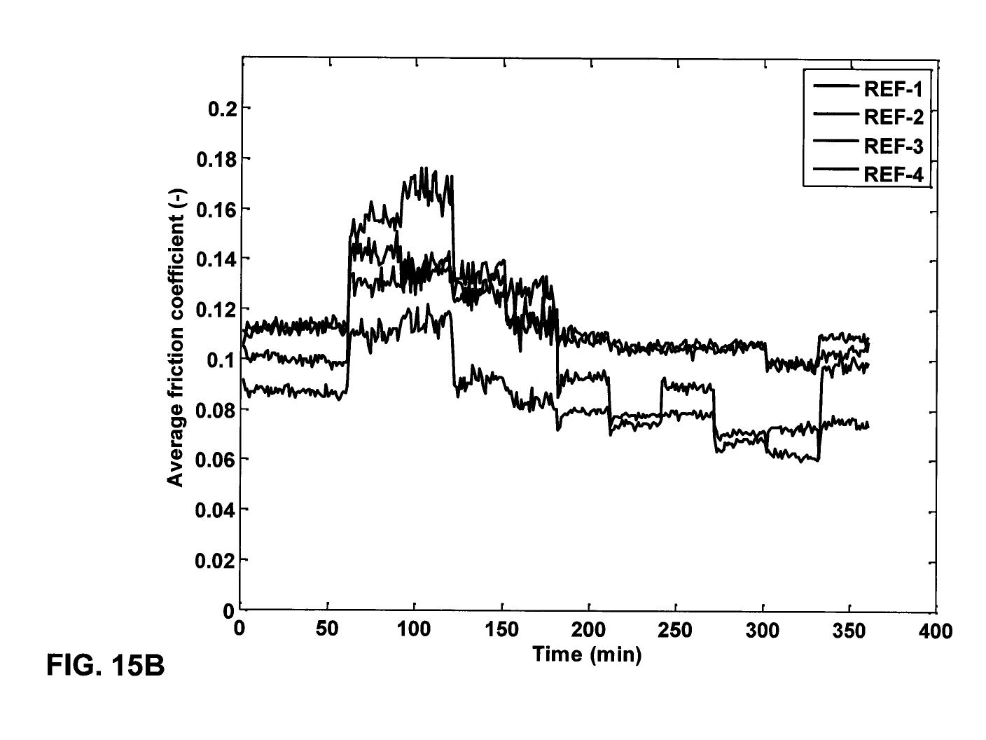

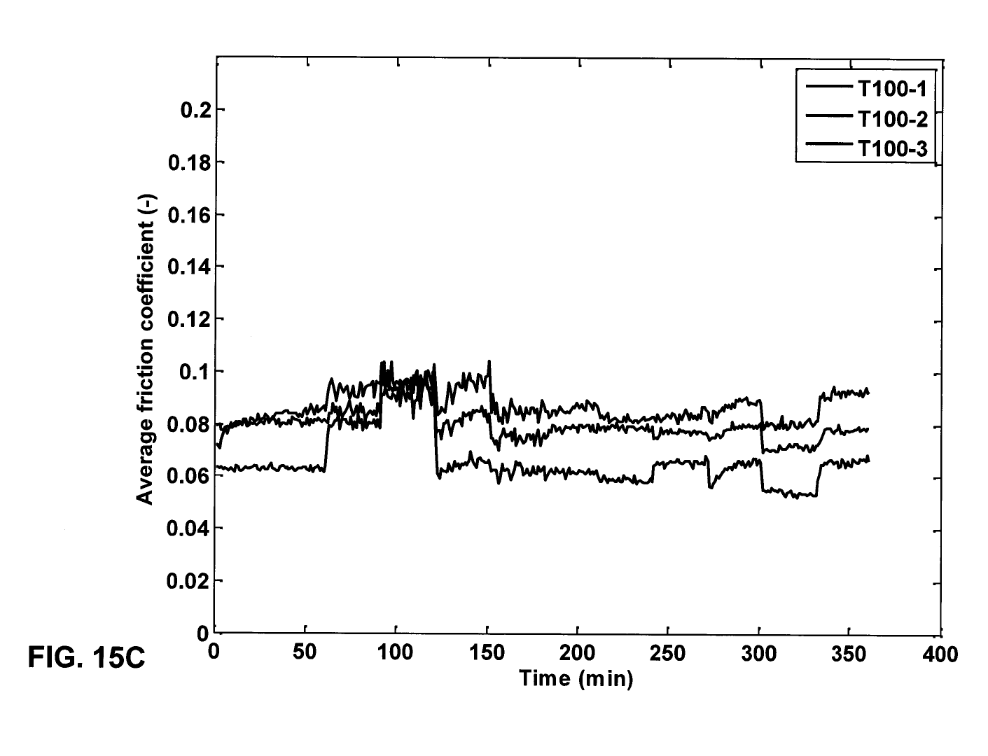

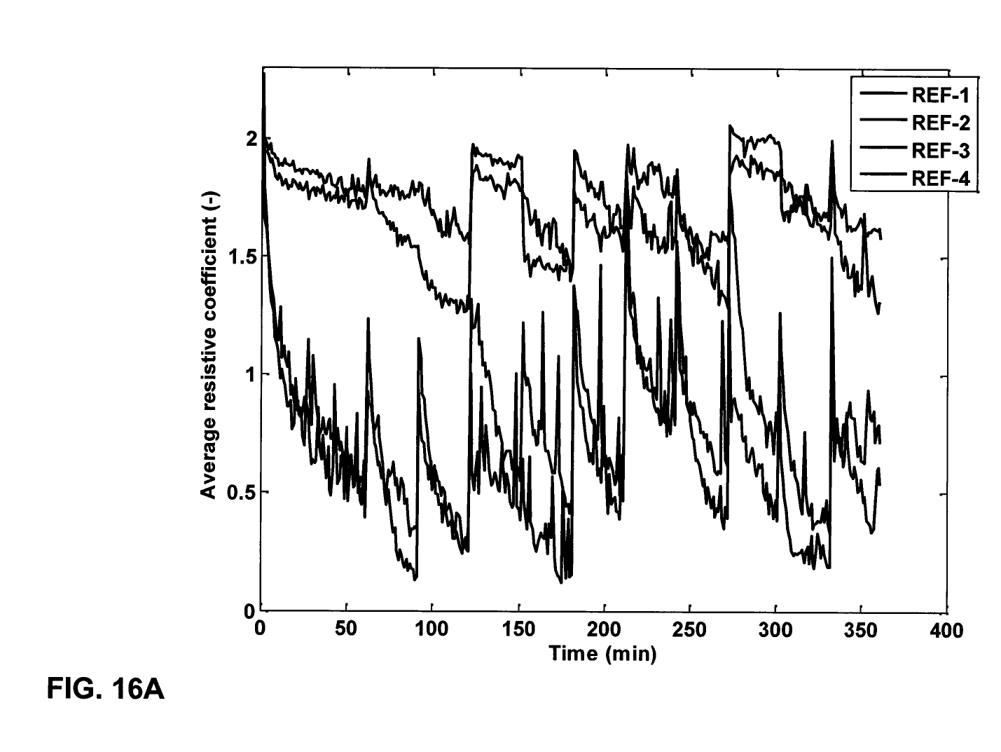

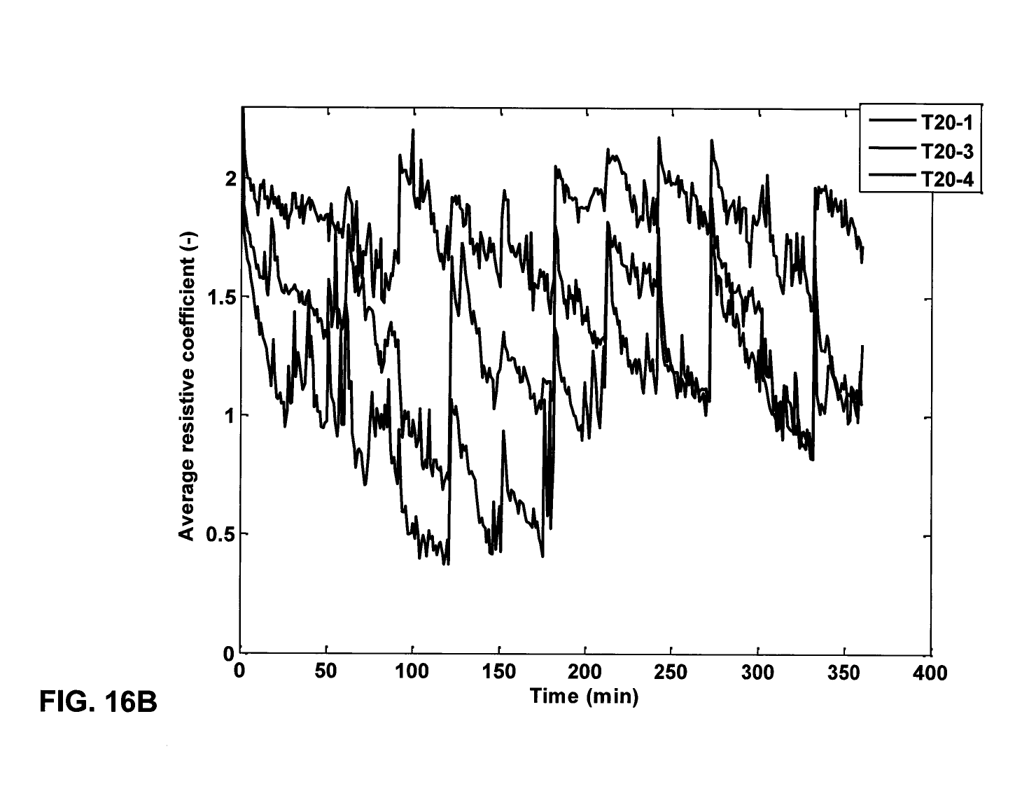

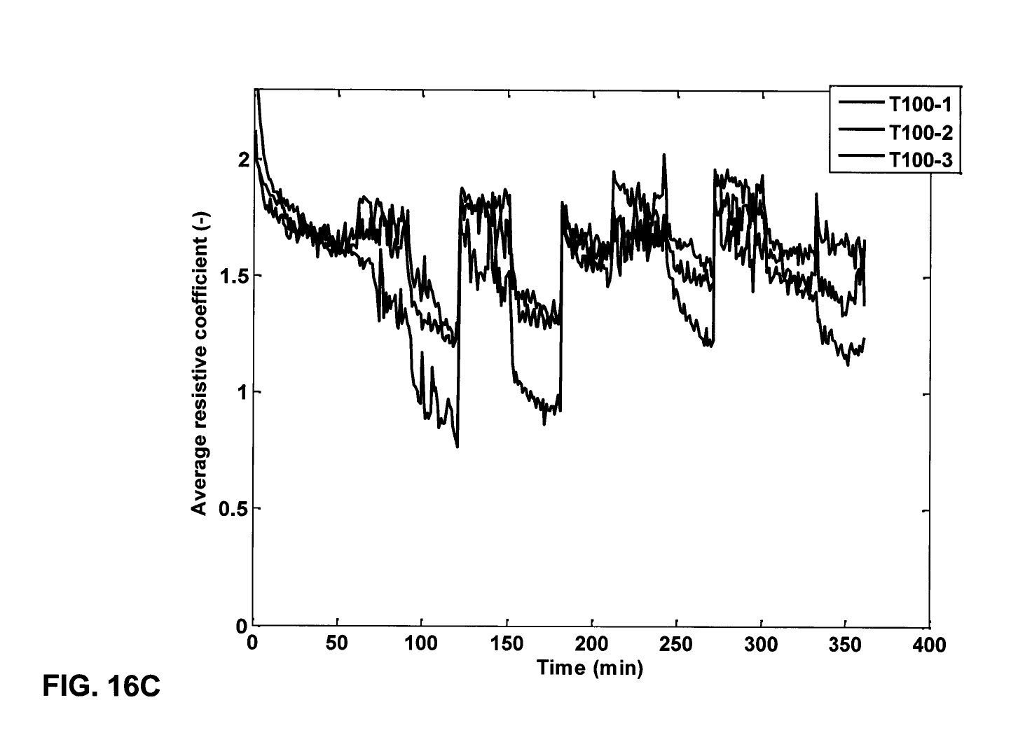

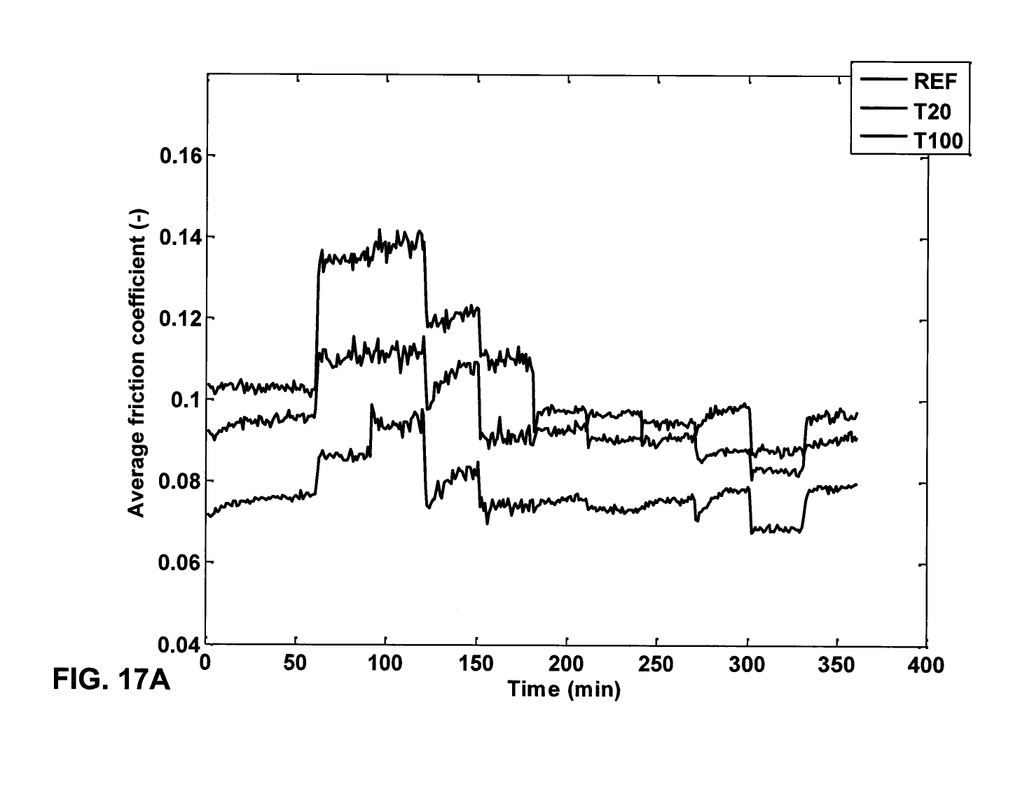

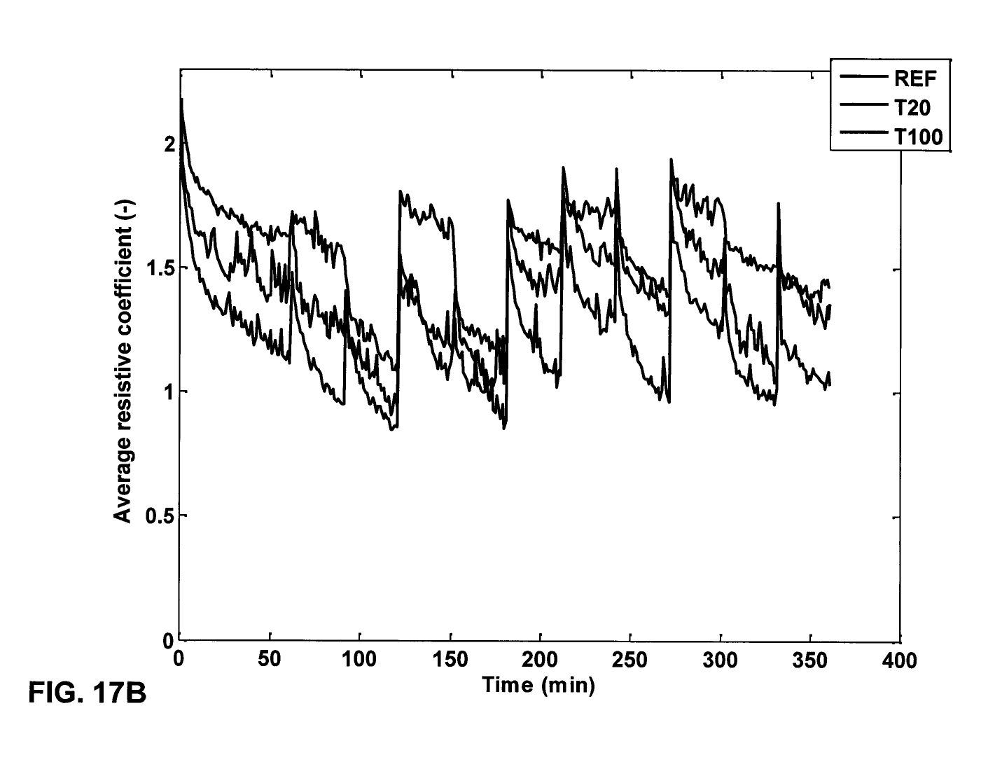

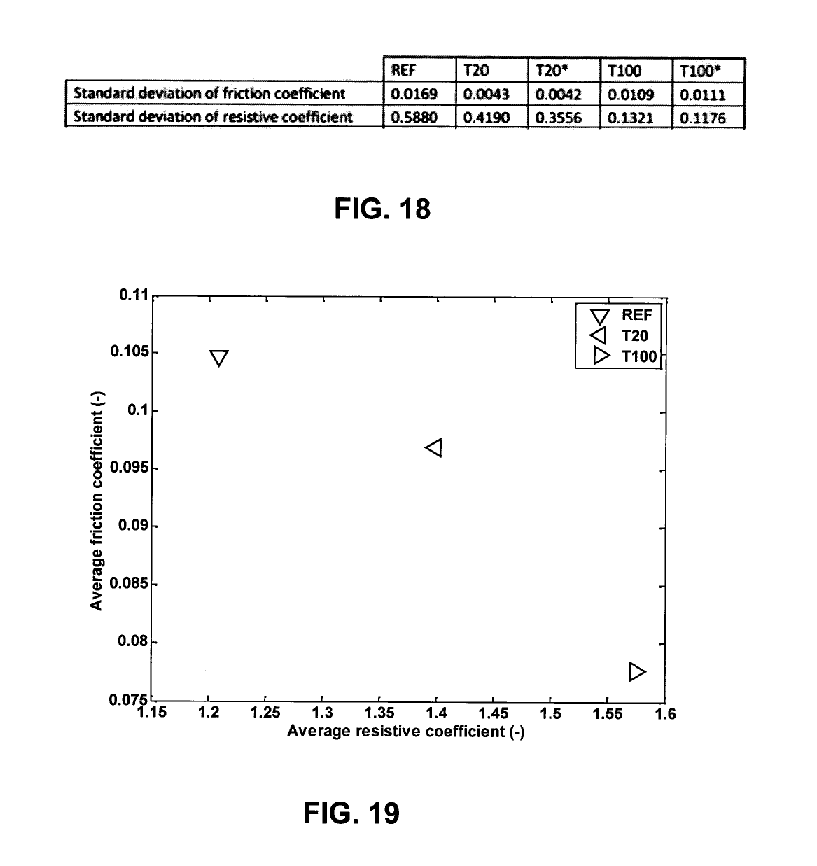

FIGS. 15A, 15B, and 15C show the measured friction coefficient for all tests (except for those samples that were removed) on the reference, T-20, and T-100 samples, respectively, and, in FIG. 17A the average friction coefficient values for each sample surface (REF, T20, and T100) is shown. The resistive coefficient was measured in the tribometer experiment. FIGS. 16A, 16B, and 16C show the resistive coefficient for all tests (except for those samples that were removed) on the reference, T-20, and T-100 samples and in FIG. 17B the average resistive coefficient values for each sample surface (REF, T20, and T100) is shown. FIG. 18 is a table that shows average values of standard deviation of friction coefficient and resistive coefficient for the samples. T20 and T100 represents the values of standard deviation for the reduced set of experiments, T20* and T100* represents the values of standard deviation for all experiments, i.e., without removal of samples T20-2 and T100-4.

FIG. 19, which shows the average values of friction coefficient for all experiments and DoE cycle steps for each surface types plotted against the average of resistive coefficient for all experiments and DoE cycle steps for each surface type, is evidence that resistive coefficient decreases as friction increases.

I. Tribometer—Evaluation of Friction Coefficient, DoE Setup and Lubrication Regime

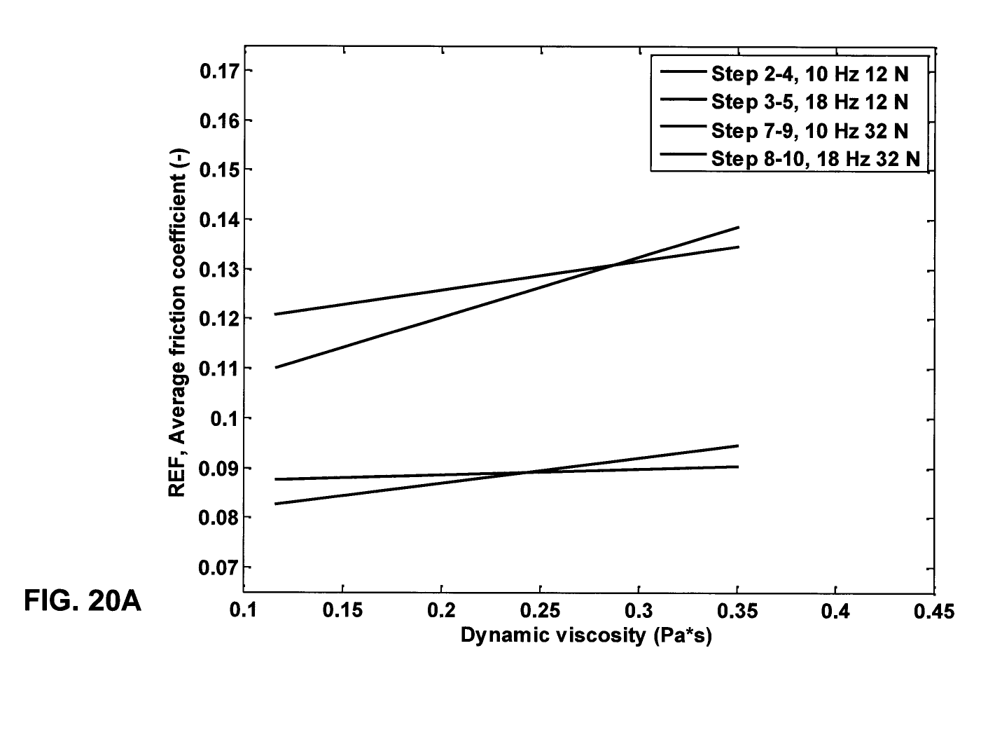

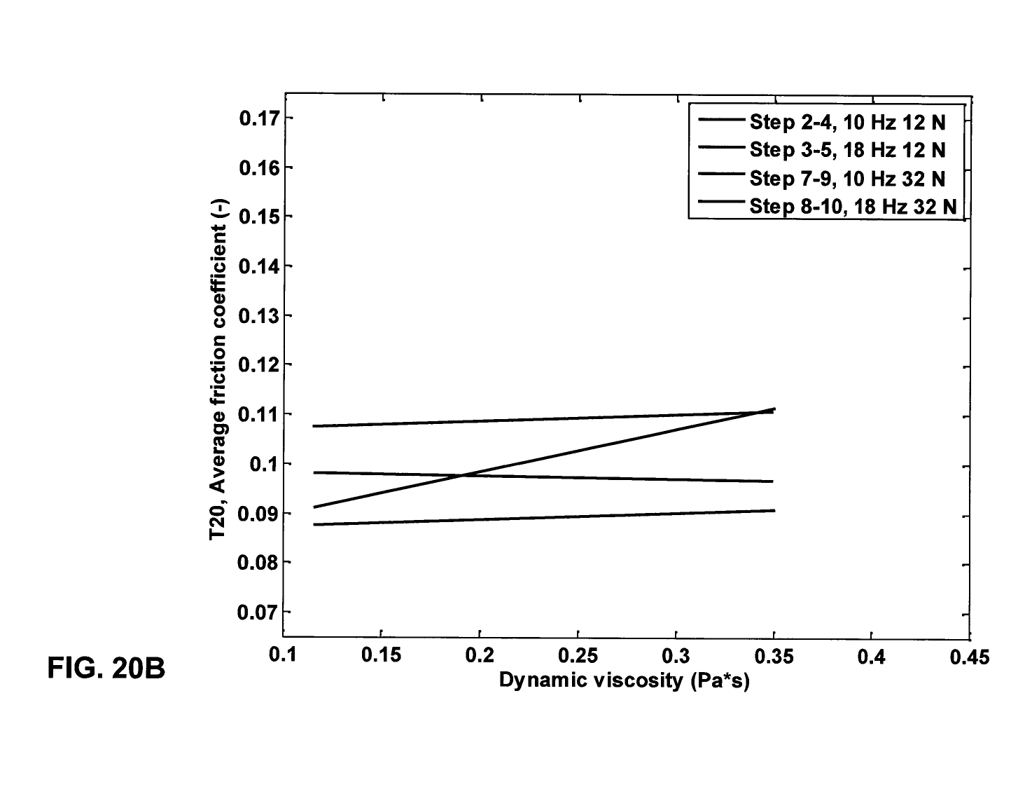

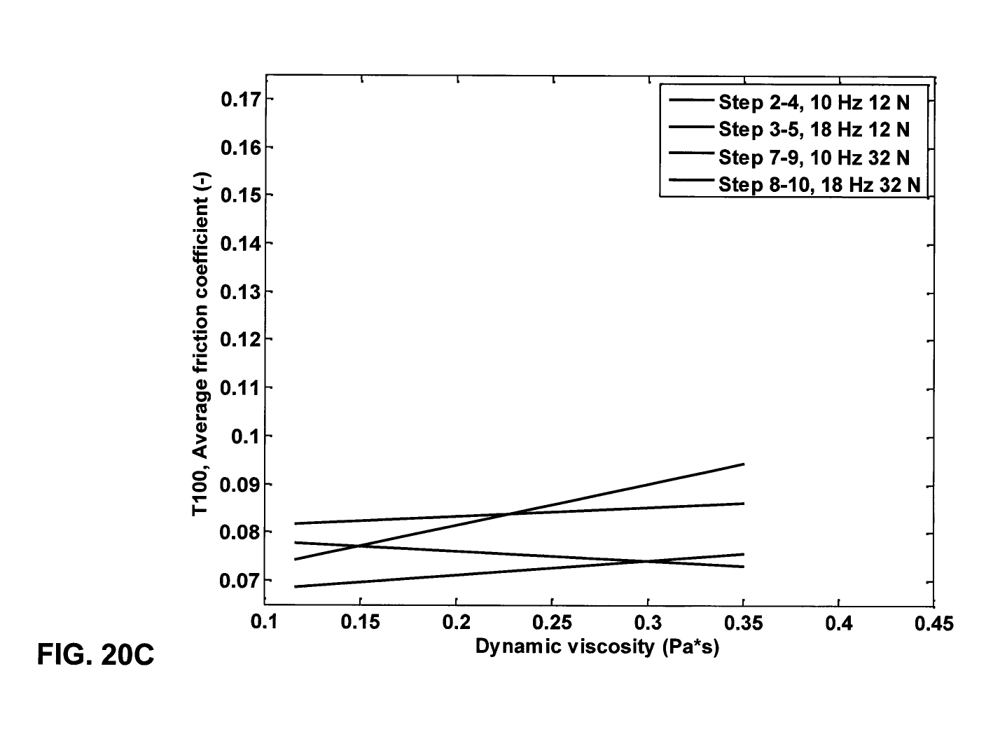

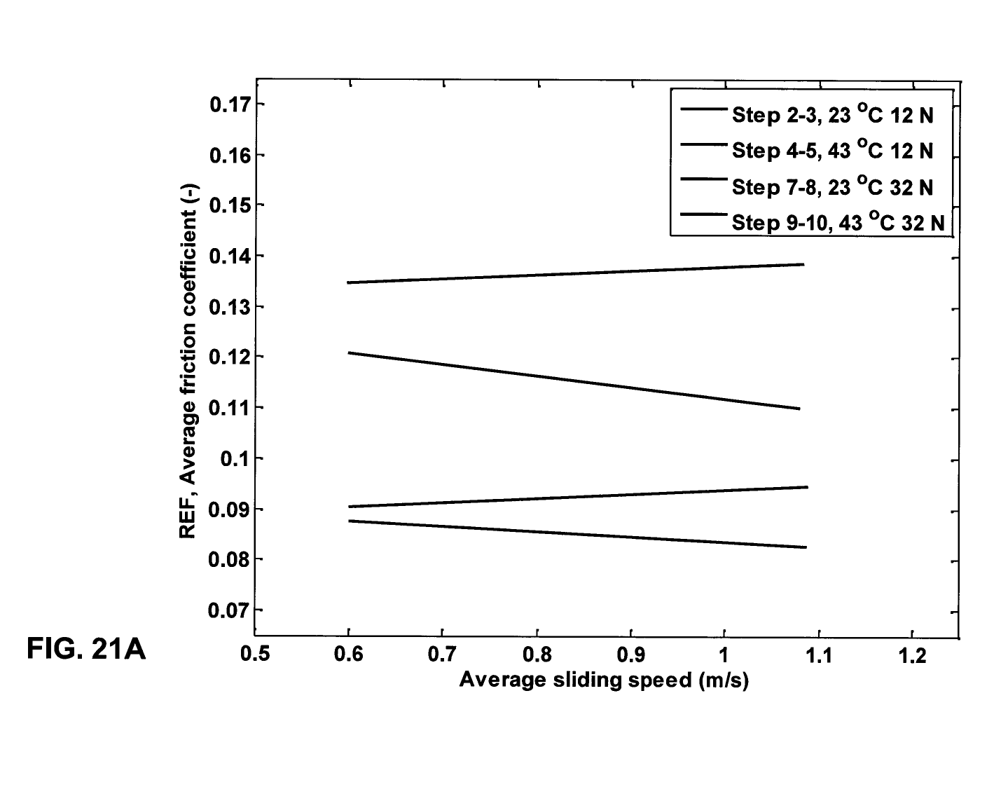

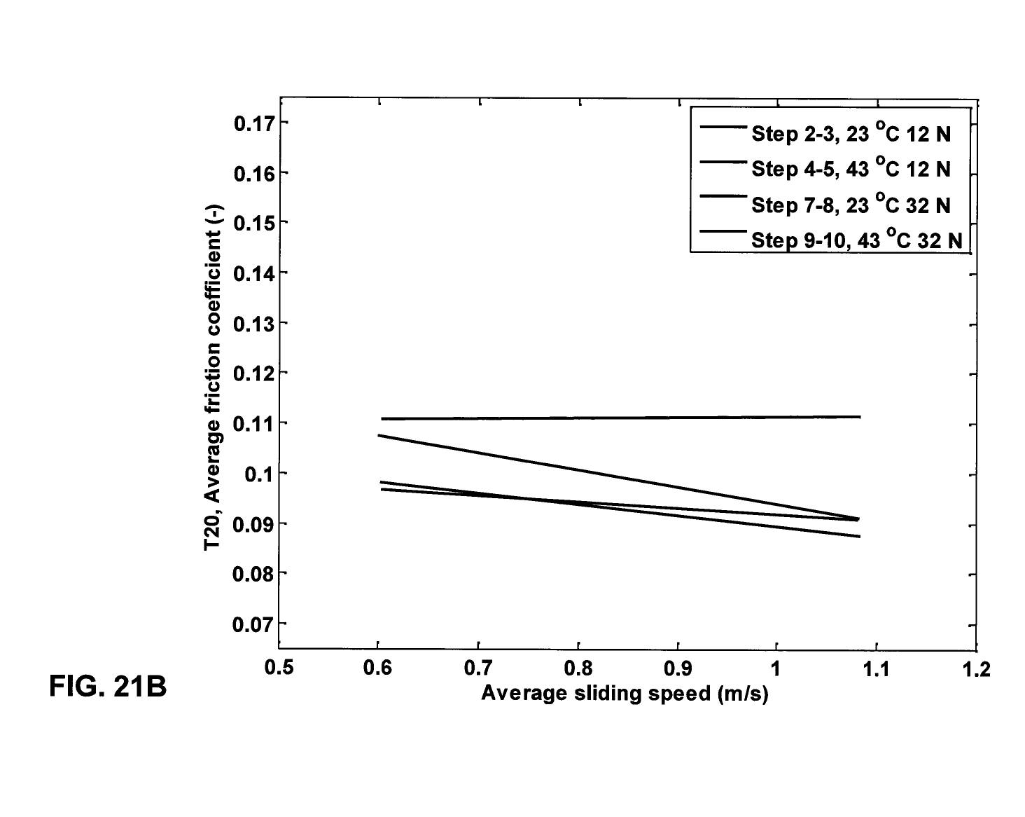

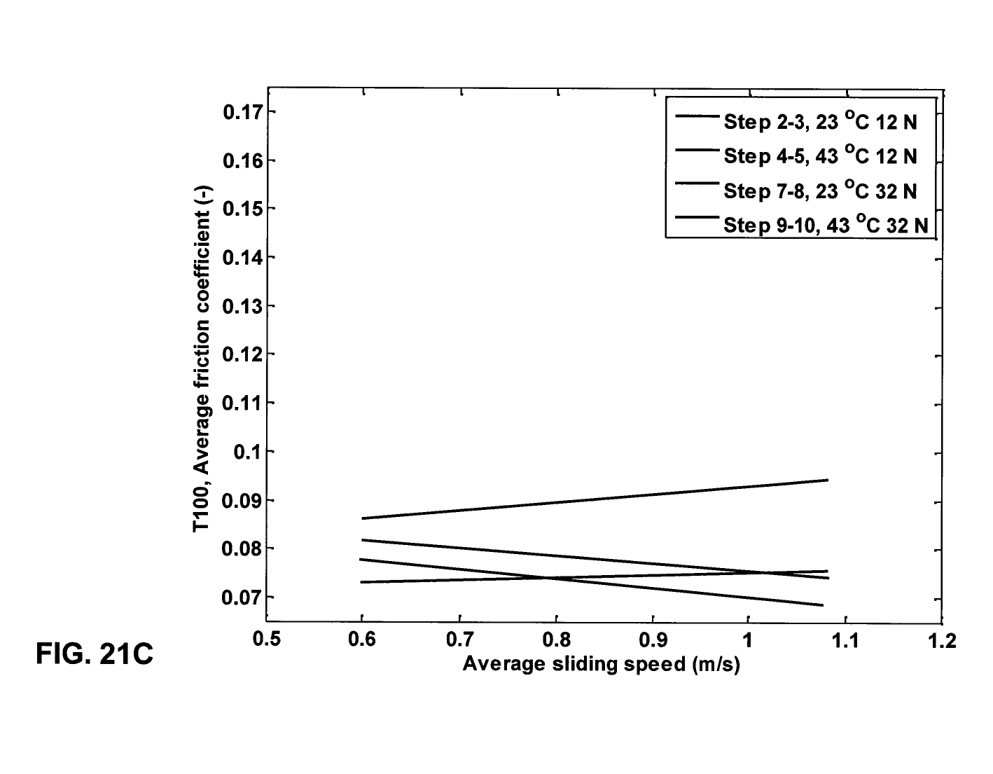

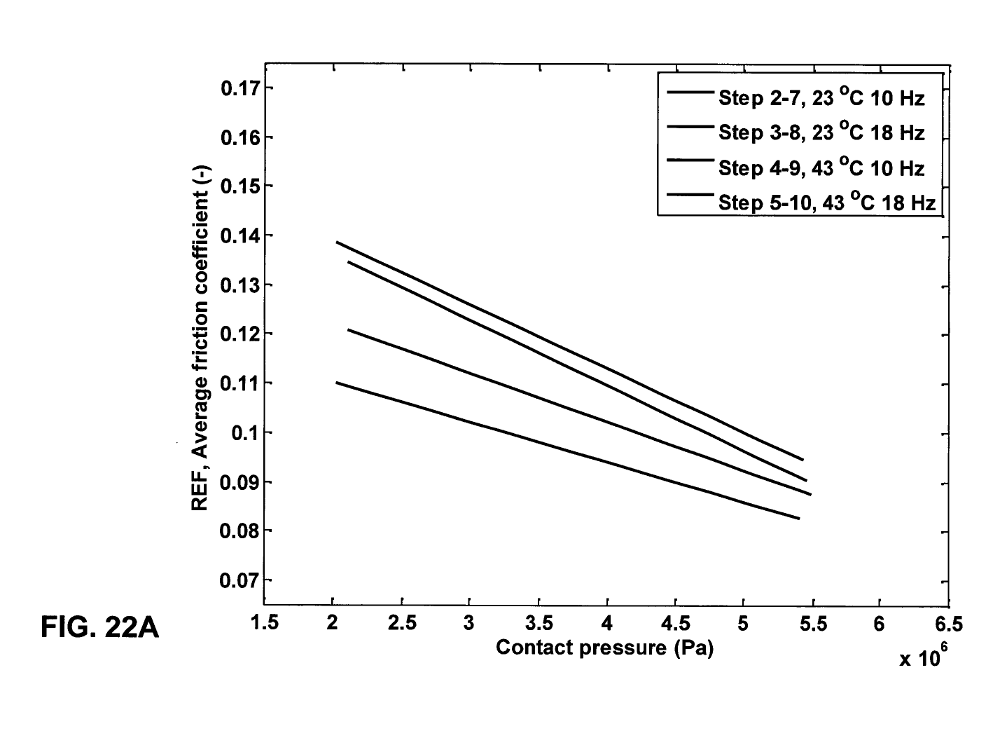

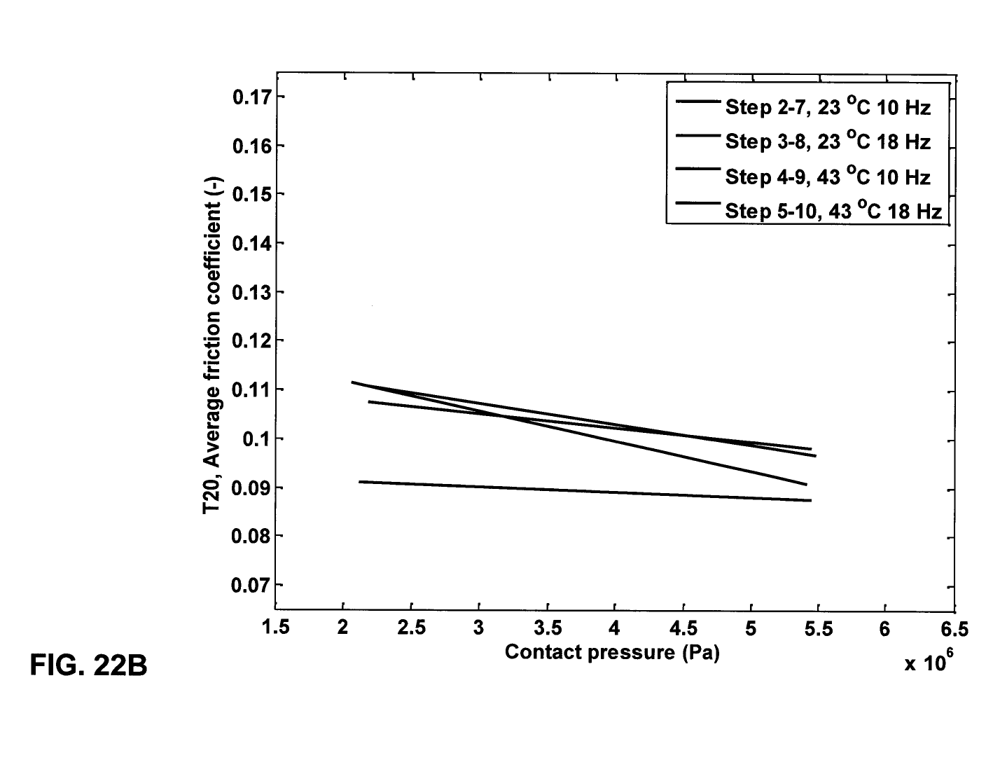

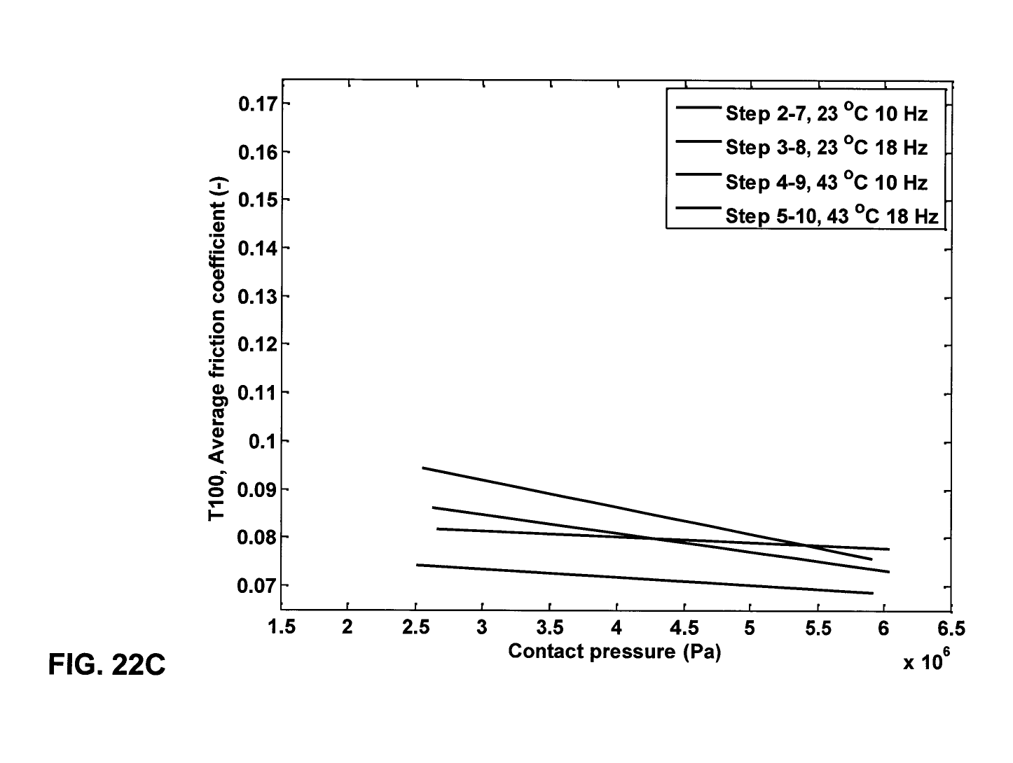

For an illustrative analysis of different lubrication regimes, the cycle steps were plotted for each input cycle step. What signifies a hydrodynamic lubrication regime is that friction increases for an increase in speed, an increase in oil viscosity and a decrease in contact pressure. Each of the cycle steps in the DoE setup plotted in FIGS. 20A-20C (Average Friction Coefficient versus Dynamic Viscosity), 21A-21C (Average Friction Coefficient versus Average Sliding Speed), and 22A-22C (Average Friction Coefficient versus Contact Pressure) was 30 minutes. To minimize the effect of transitions (e.g. thermal) between cycle steps, the values of friction coefficient were only calculated for the duration 10-29 minutes within each cycle point. Each point in this statistical analysis represents the mean of all experiments for each surface.

On analyzing of the lubrication transitions for the reference surface (REF) it was shown that:
A shift towards the hydrodynamic lubrication regime was present for both an increase in dynamic viscosity and a decrease in contact pressure.
A shift towards the hydrodynamic lubrication regime was present for low values of temperature (high level of viscosity). A shift towards a boundary lubrication regime was present for high values of temperature (low level of viscosity).

On analyzing of the lubrication transitions for the textured surfaces (T20 and T100) it was shown that:
A shift towards the hydrodynamic regime was present for a decrease in contact pressure (as for reference surface).
A shift towards the hydrodynamic regime was present for an increase in dynamic viscosity for all cycle steps except for the cycle step with high level of load and low level of reciprocating frequency.
A shift towards the hydrodynamic regime was present for an increase in increase in sliding speed at low level of load and high level reciprocating frequency. A shift towards the boundary lubrication is present for high values of temperature (as for reference surface). For high level of load and low level of temperature T20 and T100 shows slightly different results where an increase in sliding speed shows a shift towards the boundary lubrication regime for T20 and a shift towards the hydrodynamic lubrication regime for T 100.

The following conclusions can be drawn for the analysis of cycle steps and transitions of lubrication regime:
The highest measured friction in the experimental step was achieved by combining high sliding speed, high dynamic viscosity, and low contact pressure. Thus the friction was highest for contact with the greatest hydrodynamic lubrication condition.
The contact pressure at the investigated levels has the most significant impact on friction.
In general the textured surfaces have the same frictional behavior as the reference surfaces in the sense that they all behave similarly in response to different conditions, although some differences are present for textured surfaces with a shift towards the boundary lubrication regime, however, at low contact pressure and high viscosity the friction increases with increased sliding speed for all investigated surfaces and, thus, a shift towards the hydrodynamic lubrication regime is present for this contact condition for all surfaces, textured or untextured.

### II. Analysis of Behavior of Oil Film Thickness and Textures

In spite of an increase in contact (increased resistive coefficient), it has been observed that friction decreases for textured surfaces relative to non-textured surfaces. The interaction between two opposing surfaces in sliding motion in which one of these surfaces is textured can be viewed from two perspectives: either the contact is between the plateaus of the two surfaces (plateau of cylinder liner vs. plateau of piston ring) or the contact is between the plateau part of the piston ring and the texture element of the textured surface (texture element of cylinder liner vs. plateau of piston ring). In other words, either the piston ring is sliding over an untextured part of the cylinder liner or the piston ring is sliding over a texture (or texture element). Eqn. (2) describes shear force, F_{T}, for two parallel planes fully separated by a Newtonian fluid.

$${F}_{T} = \frac{η vA}{h} = η SA \qquad ( 2 )$$

### Where:

F_{T}—shear force;
A—area between surfaces
h—oil film thickness
v—sliding velocity
η or μ—dynamic viscosity
S=v/h—shear rate
When a mating surface, e.g., a piston ring passes over a texture element, the area, A, is unaltered for the passage because the surface is not decreased or removed, there are still two parallel planes, although when the mating surface passes a texture element the planes are further apart compared to the distance between the two plateaus of the mating surfaces.

In an analysis of the oil viscosity it is important to account for the non-Newtonian shear rate behavior of the engine oil. The shear rate is dependent on oil film thickness, h, and sliding velocity, v₀ (Eqn. (3)). The dynamic viscosity, η or μ, is dependent on the shear ratio; for low levels of shear rate the value of viscosity value is assumed that of zero-shear, μ₀ and for high levels of shear rate the value of viscosity value is assumed that of infinite-shear, μ_{∞} (Eqn. (4)).

$$\begin{matrix}S = \frac{{v}_{0}}{h} & ( 3 ) \\ μ = {μ}_{∞} + \frac{{μ}_{0} - {μ}_{∞}}{1 + γ / {γ}_{c}} & ( 4 )\end{matrix}$$

As was shown in the experimental study, the resistive signal increases for the textured surfaces relative to the reference surfaces (see FIGS. 16A, 16B, and 16C), which indicates that the amount of metal to metal contact increases for the textured surfaces compared to the reference surface. When a surface passes a texture element, the oil film thickness increases and thus η or μ increases, however, the oil film thickness decreases when passing a plateau and, thus, η or μ decreases. The effect of viscosity on shear force is, however, not believed to be highly significant because the decrease of dynamic viscosity for passage of plateaus is partially cancelled out by the increase in dynamic viscosity for passage of a texture element.

Thus, there is no alteration of the area A and it is believed that there is no significant alteration of the dynamic viscosity η or μ for a textured surface compared to the reference surface. There is, however, a significant increase in the oil film thickness h upon passage of a texture element if the oil film thickness is considered as the entire depth of the texture element. As the resistive signal data reflects that the amount of metal to metal contact increases for the textured surface compared to the reference surface, this shows that there was generally a thicker oil film href (see FIG. 16) between a reference surface and the opposing surface compared to the oil film hoT (oil film thickness outside of texture) between the plateau of a textured surface and the opposing surface. However, for the textured surfaces, when the opposing surfaces passed a texture element, the oil film thickness can be considered to be the same as the texture element depth, because the contact between piston ring and cylinder liner is fully-flooded. The increase in metal to metal contact for the textured surfaces is understood to be due to a decrease in the build-up of hydrodynamic pressure. There are two causes for loss of hydrodynamic pressure: (1) because of leakage of oil into the texture element; and (2) because less surface area is available for the generation of hydrodynamic pressure. The amount of metal to metal contact is greater for T100 compared to T20, because the area of the texture elements were practically the same, which is understood to mean that the leakage of oil into the texture is greater for the T100 textured surface.

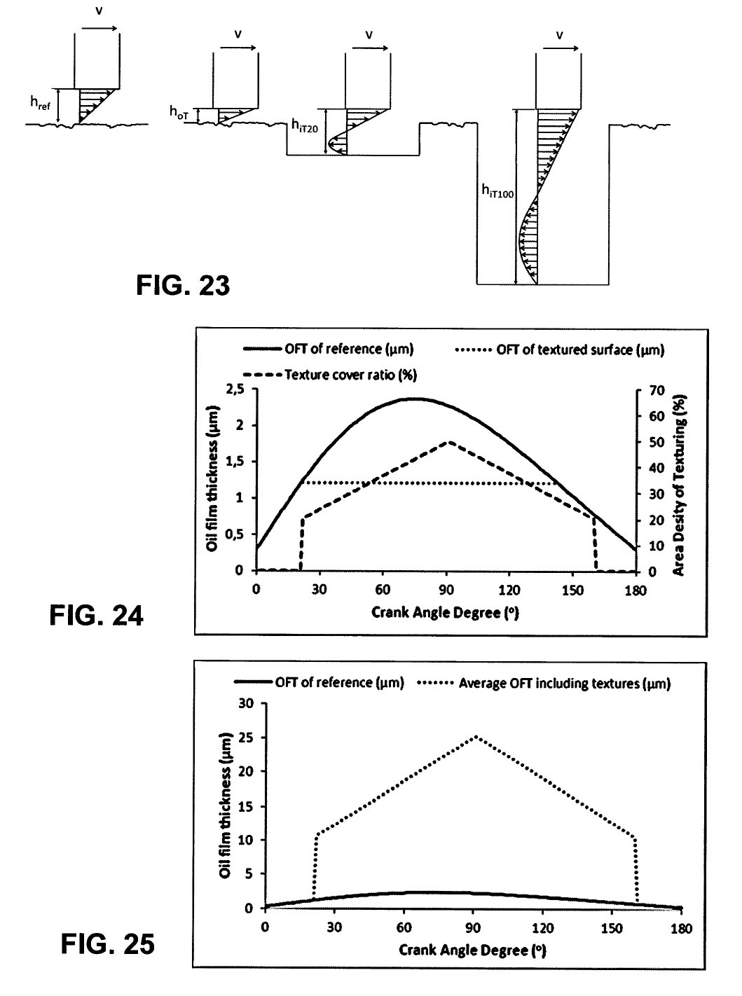

In the tribometer experiment fully flooded conditions were maintained for all experimental conditions. Consequently, an oil film thickness h_{iT100} over a texture element on the T100 surface was five times larger than the oil film thickness h_{iT20} over a texture element on the T20 surface as seen in FIG. 23. The surface T20 exhibited a larger friction coefficient for some experimental cycle steps in which high load was used (e.g., cycle step 9). The reason for this is believed to be that the increase in boundary friction for passage of a plateau was greater than the decrease in viscous losses for passage of a texture element, which thus combined to create a higher friction than the friction of the reference surface.

A. Effect of Texture Properties in Relation the Design of Cylinder Liner Surfaces

Textured surfaces with elements of geometry similar to the ones investigated in this application can be applied to cylinder liner surfaces to decrease hydrodynamic friction. However, this statement is qualified to the extent that it is presently not believed to be optimal to provide texture elements in the reversal zones due to:
Low sliding speeds in the reversal zones and, thus, hydrodynamic friction losses are small.
Due to high temperature at the upper reversal zone the oil viscosity is low thus the hydrodynamic friction losses are small.
In the combustion stroke the gas pressure is high, and the gas pressure causes high contact pressure between the top ring and the cylinder liner. An addition of textures in a severe tribological contact could increase wear (see A Kovalchenko et al., Friction and wear behaviour of laser textured surface under lubricated initial point contact. Wear 271 (2011) 1719-1725, which is incorporated by reference) thus it is not regarded as being beneficial to apply texture elements with similar dimensions as investigated in this study in the vicinity of the upper reversal zone.

The surface angle in the boundary between texture and plateau was high for the analyzed texture elements. This is believed to be preferable because the oil film will be higher at a surface larger area. In perspective, this could be regarded as either: (a) the counter body slides over a texture with high film thickness; or (b) it slides over plateau surface to build up oil film between the two mating surfaces. Passing a texture element provides decreased hydrodynamic friction losses. The passage of a plateau provides oil film build-up between piston ring and cylinder liner. To minimize an increase in mechanical frictional of the passage of a plateau it is important produce a smooth surface on the plateaus.

The addition of a texture on a surface increases the surface volume. It is thus important to analyze the effects of the increased surface volume on blow-by and oil consumption. The effects on blow-by and oil consumption of different types of cylinder liner surfaces was analyzed in T. Hegemier, M. Stewart, Some Effects of Liner Finish on Diesel Engine Operating Characteristics. Proceedings of International Congress and Exposition, Detroit, Mich., Mar. 1-5, 1993 (Hegemier et al.), although the analyzed surfaces differed from the surface texturing of the present invention. Hegemier et al. found that different surface finishes had little effect on blow-by and that the dominating factor that controlled oil consumption was the amplitude of the plateau roughness. Still, the inventor suggests that it may be useful to optimize the geometries of the piston rings for efficient control of blow-by and oil consumption. Analysis of the effects on blow-by and oil consumption with different designs of gas tight top rings may be useful to minimize oil consumption and blow-by. Y Tateishi, Tribological issues in reducing piston ring friction losses. Tribology International, Volume 27 Number 1, 1994

A study (T. Seki et al. A study on variation in oil film thickness of a piston ring package: variation of oil film thickness in piston sliding direction. JSAE Review 21, pp. 315-320, 2000) that experimentally analyzed the oil film thickness (OFT) between piston rings and cylinder liner showed that OFT increases with sliding speed.

The following provides an illustrative prophetic example of how the inventor believes that friction in diesel engine cylinders might be reduced by applying surface textures. The example assumes that oil film thickness increases linearly with sliding speed (a generalization although not that different from the study carried out by Seki et al.) according to the solid line curve in FIG. 24 for a reference plateau honed cylinder liner. A varying area density of uniform texturing elements (with the geometry of T100) is applied on a cylinder liner surface. The area density of this texturing increases linearly from 21-90 crank angle degrees and decreases linearly from 90-159 crank angle degrees as seen by the dashed line in FIG. 24. In this example, 21 crank angle degrees is the location on the cylinder liner to which the oil control ring on a piston moves, and 159 crank angle degrees is the location on the cylinder liner to which the top ring moves, so that there is an equal distribution of texturing elements between the upper reversal zone of the oil control ring and the lower reversal zone of the top ring. In this example no texturing is added at the position of 0-20 crank angle degrees and at the position of 160-180 crank angle degrees. On the untextured part of the textured cylinder liner it is assumed that the oil film thickness is the same as for a reference cylinder liner. We also assume that the oil film thickness is the same for the textured cylinder liner compared to reference cylinder liner for crank angle degrees that have a smaller value of oil film thickness compared to the constant value of oil film thickness. By controlling the area density of the texturing, the oil film thickness between the plateau of the cylinder liner and the piston ring can be controlled so that it does not increase for crank angle 21-159 but, rather, is maintained at a constant value over the length of the textured surface as seen by the dotted line in FIG. 24. It is presently contemplated that this can be accomplished by varying the area density of texture elements of the available surface area between 20% closest to crank angle 21 and 50% at crank angle 90.

As seen by the dotted line in FIG. 25, the average oil film thickness for the textured surface including the oil film height within the texture elements will thus be significantly higher than the oil film thickness for the reference surface (solid line in FIG. 25), and by this it is contemplated that there will be a decrease the hydrodynamic friction.

Using texture elements with varying area density is one example how hydrodynamic friction can be reduced, however, it is also contemplated that hydrodynamic friction can be efficiently reduced by varying the depth of texture elements as a function of stroke length. In the prophetic example discussed above, texture area density can be varied starting from, for example, 20% area density at the position 21 crank angle degrees (location of the top piston ring), can increase to, for example, 50% area density at mid stroke, and can decrease to, for example, 20% are density at 159 crank angle degree (location of oil control ring). It is also possible to decrease hydrodynamic friction by varying the depth of texture elements. In relation another prophetic example, such a design might include texture elements with uniform size (axial and tangential length) and a fixed area density along the textured portion of the stroke length. However, the depth of the texture elements could start at a depth of, for example, 35 μm at 21 crank angle degrees (location of the top piston ring), the depth of texture elements could increase to, for example, 100 μm at mid stroke, and the depth of texture elements could decrease to, for example, 35 μm at 159 crank angle degree (location of oil control ring).

It is also contemplated that hydrodynamic friction can be efficiently reduced by varying both the texture depth and the area density. There are several possible ways in which area density can be varied
1. The texture elements might have a uniform size (axial and tangential length), and the quantity of texture elements per unit area might be varied along the stroke so that the area density will be varied.
2. The texture elements might have varying size (axial and tangential length), and the quantity of texture elements per unit area might be kept constant to provide a variation of the area density because texture elements with larger size decrease the amount of plateau area and texture elements with smaller size increase the amount of plateau area.
3. A combination of 1. and 2.

In both 1. and 2. and in relation to the prophetic example the design of both varying texture area density and texture depth would include textures that would start with a depth of 35 μm and an area density of 20% at 21 crank angle degrees (location of the top piston ring), the depth of textures would increase to 100 μm and texture are density to 50% at mid stroke, and the depth of textures would decrease to 35 μm and texture area density would decrease to 20% at 159 crank angle degree (location of oil control ring).

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A combustion engine, comprising:
a combustion engine piston cylinder comprising an interior wall surface, the interior wall surface having a textured pattern comprising a plurality of texture elements over at least part of an axial length of the interior wall surface, wherein a volume of the texture elements of the textured pattern for a given surface area of the interior wall surface increases toward a center of the axial length of the interior wall surface.

2. The combustion engine as set forth in claim 1, wherein a depth of texture elements forming the textured pattern increases toward a center of the axial length of the interior wall surface.

3. The combustion engine as set forth in any of claims 1-2, wherein a depth of texture elements forming the textured pattern increases relative to a depth of texture elements forming the textured pattern further from the center of the axial length of the interior wall.

4. The combustion engine as set forth in any of claims 1-3, wherein both toward the center of the axial length of the interior wall surface and in regions more remote from the center of the axial length of the interior wall the textured pattern comprises substantially a same percentage of the given surface area of the interior wall surface.

5. The combustion engine as set forth in any of claims 1-3, wherein the textured pattern comprises a larger percentage of a given surface area of the interior wall surface toward the center of the axial length of the interior wall surface than in regions more remote from the center of the axial length of the interior wall.

6. The combustion engine as set forth in any of claims 1-5, wherein the interior wall surface has a textured pattern over an axial length of the interior wall surface below a top reversal zone.

7. The combustion engine as set forth in any of claims 1-6, wherein the interior wall surface has a textured pattern over an axial length of the interior wall surface above a bottom reversal zone.

8. The combustion engine as set forth in any one of claims 1-7, wherein the textured pattern comprises a plurality of texture elements in the form of depressions.

9. The combustion engine as set forth in claim 8, comprising a piston movable axially in the cylinder, a minimum axial height of the depressions being greater than a minimal axial length of a contact area between the interior wall surface and any part of the piston or piston rings on the piston over any textured portion of the interior wall surface.

10. The combustion engine as set forth in claim 9, wherein the axial height of the depressions is between substantially 300-6000 μm.

11. The combustion engine as set forth in any one of claims 8-9, wherein a minimum width of the depressions is greater than a minimal circumferential width of a contact area between the cylinder and any part of the piston or piston rings over any textured portion of the interior wall surface.

12. The combustion engine as set forth in any one of claims 8-11, wherein the width of the depressions is between substantially 300-6000 μm.

13. The combustion engine as set forth in any of claims 8-12, wherein a depth of the depressions is between substantially 20-200 μm.

14. The combustion engine as set forth in any of claims 8-13, wherein a minimum depth of the depressions is substantially equal to 35 μm.

15. The combustion engine as set forth in any of claims 8-14, wherein the depressions each have one of a substantially circular, oval, or elliptical shape.

16. The combustion engine as set forth in any of claims 8-15, wherein the depressions each have radiused ends at opposite axial ends of the depressions.

17. The combustion engine as set forth in any of claims 8-16, wherein the depressions each have a maximum dimension extending in an axial direction of the cylinder.

18. The combustion engine as set forth in any of claims 1-17, wherein the textured pattern forms one or more plateaus and a textured area that is between substantially 5-50% of a total area of the at least part of the axial length of the surface having the textured pattern.

19. The combustion engine as set forth in any of claims 1-7, wherein the textured pattern comprises a plurality of texture elements in the form of a plurality of substantially parallel grooves.

20. The combustion engine as set forth in any of claims 1-7 and 19, wherein plurality of substantially parallel grooves forms a non-zero angle with a longitudinal axis of the cylinder.

21. The combustion engine as set forth in claim 20, wherein the textured pattern comprises a second plurality texture elements in the form of substantially parallel grooves that form a second, non-zero angle with the longitudinal axis of the cylinder, the second angle being different than the first angle.

22. The combustion engine as set forth in claim 21, wherein the first angle and the second angle are substantially equal, but opposite angles.

23. The combustion engine as set forth in any of claims 1-22, wherein the cylinder comprises a cylinder liner, and the interior wall surface is the interior wall surface of the cylinder liner.

24. A combustion engine, comprising:
a combustion engine piston cylinder comprising an interior wall surface, the interior wall surface having a textured pattern of texture elements over at least part of an axial length of the interior wall surface, wherein a depth of the elements increases toward a center of the axial length of the interior wall surface.

25. A cylinder liner for a combustion engine piston cylinder comprising an interior wall surface, the interior wall surface having a textured pattern of texture elements over at least part of an axial length of the interior wall surface, wherein a volume of the texture elements of the textured pattern for a given surface area of the interior wall surface increases toward a center of the axial length of the interior wall surface.

26. A cylinder liner for a combustion engine piston cylinder comprising an interior wall surface, the interior wall surface having a textured pattern of texture elements over at least part of an axial length of the interior wall surface, wherein a depth of the texture elements increases toward a center of the axial length of the interior wall surface.

27. A combustion engine piston cylinder comprising an interior wall surface, the interior wall surface having a textured pattern of texture elements over at least part of an axial length of the interior wall surface, wherein a depth of the elements increases toward a center of the axial length of the interior wall surface.

28. A combustion engine piston cylinder comprising an interior wall surface, the interior wall surface having a textured pattern of texture elements over at least part of an axial length of the interior wall surface, wherein a volume of the texture elements of the textured pattern for a given surface area of the interior wall surface increases toward a center of the axial length of the interior wall surface.

29. A combustion engine piston cylinder comprising an interior wall surface, the interior wall surface having a textured pattern of texture elements over at least part of an axial length of the interior wall surface, wherein a depth of the texture elements increases toward a center of the axial length of the interior wall surface.

30. A combustion engine, comprising:
a combustion engine piston cylinder comprising an interior wall surface, the interior wall surface having a textured pattern comprising a plurality of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

31. The combustion engine as set forth in claim 30, wherein a depth of texture elements forming the textured pattern increases relative to a depth of texture elements forming the textured pattern further from the center of the axial length of the interior wall.

32. A cylinder liner for a combustion engine piston cylinder comprising an interior wall surface, the interior wall surface having a textured pattern of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

33. The cylinder liner for a combustion engine as set forth in claim 32, wherein a depth of texture elements forming the textured pattern increases relative to a depth of texture elements forming the textured pattern further from the center of the axial length of the interior wall.

34. A combustion engine piston cylinder comprising an interior wall surface, the interior wall surface having a textured pattern of texture elements over at least part of an axial length of the interior wall surface, wherein an area density of the texture elements of the textured pattern for a given surface area of the interior wall surface increases toward a center of the axial length of the interior wall surface by increasing at least one of a height and width of the textures elements per unit area toward the center of the axial length of the interior wall surface.

35. The combustion engine piston cylinder liner as set forth in claim 34, wherein a depth of texture elements forming the textured pattern increases relative to a depth of texture elements forming the textured pattern further from the center of the axial length of the interior wall.
